(19) United States
(12) Patent Application Publication
(10) Pub. No.: US 2024/0087030 A1
(43) Pub. Date: Mar. 14, 2024

(54) Method And System For Performing Merchant Cash Advances

(71) Applicant: Supervest, Inc., Schaumburg, IL (US)

(72) Inventors: Kris KEHLER, Cary, IL (US); Jeremy MORTON, Bloomfield Hills, MI (US)

(21) Appl. No.: 18/464,207

(22) Filed: Sep. 9, 2023

Related U.S. Application Data
(60) Provisional application No. 63/405,581, filed on Sep. 12, 2022.

(51) Int. Cl. G06Q 40/06

(52) U.S. Cl. CPC G06Q 40/06

(57) ABSTRACT

A method of allocating investors to an investment includes receiving an investment request signal for the investment corresponding to a requested investment amount, determining an investment quality rating for the investment; determining an investor group size for an investor group of investor devices based on the investment quality rating. Each investor device includes a criteria set of a plurality of criteria sets. The method further includes determining an investor participation amount for each investor device based on the plurality of criteria sets, generating an investor queue based on the plurality of criteria sets; communicating an investment offer to a plurality of investor devices in the queue; receiving from the plurality of investor devices a participation confirmation signal; storing participating investors in a participant table in a memory; and communicating notification signals to the plurality of investor devices in the participant table corresponding to acceptance into the investment.

### CROSS-REFERENCE TO RELATED APPLICATION

This application claims the benefit of U.S. Provisional Application No. 63/405,581, filed on Sep. 12, 2022. The entire disclosure of the above application is incorporated herein by reference.

### FIELD

The present disclosure relates to generally to a financial transaction processing system and, more particularly, to a method and system that allows multiple investors to fund investment such as merchant cash advances.

### BACKGROUND

This section provides background information related to the present disclosure which is not necessarily prior art.

A merchant cash advance (MCA) is a type of financing that is used when a company such as a merchant borrows money against income from future sales. The money is not a loan and therefore is not regulated like a loan. Because the financing is ,/against future sales, the risk for an investor can be quite high. Fees are often charged to the requesting company or merchant that correspond to the risk. The requesting company may be referred to as an originator or partner. Many companies provide MCAs. The company or person funding or providing money to requestor (merchant, originator, partner) may be referred to as an investor. However, when a single investor provides the funds to one company or merchant, there is a high risk for the investor.

### SUMMARY

This section provides a general summary of the disclosure and is not a comprehensive disclosure of its full scope or all of its features.

The present disclosure provides a system that allows a plurality of investors to be matched with an offering or investment abased upon a filter criteria data set as selected by the investor.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of allocating investors to an investment. The method also includes receiving an investment request signal for the investment, said investment request signal corresponding to a requested investment amount; determining an investment quality rating for the investment; determining an investor group size for an investor group of investor devices based on the investment quality rating, each investor device may include a criteria set of a plurality of criteria sets. The method further includes determining an investor participation amount for each investor device based on the plurality of criteria sets; generating an investor queue based on the plurality of criteria sets; communicating an investment offer to a plurality of investor devices in the queue; receiving from the plurality of investor devices a participation confirmation signal; storing participating investors in a participant table in a memory; and communicating notification signals to the plurality of investor devices in the participant table corresponding to acceptance into the investment. Other embodiments of this aspect include corresponding computer systems, apparatus, and computer programs recorded on one or more computer storage devices, each configured to perform the actions of the methods.

Implementations may include one or more of the following features. The method where after determining the investor group size determining an approximate participation amount. Receiving the investment request signal may include receiving the investment amount and investment data. The investment data may include at least four of a merchant investment identifier, a total merchant funding amount, a funder participation dollar amount, a funder participation percentage amount, a participation dollar requested amount, a participation percent requested amount, and an advance type. The advance type may include a new investment, a renewal investment or an add-on investment. Determining an investment quality rating may include determining at least one of a time in business, a credit score, a lien position, a participation amount and an investment default rate. Determining an investment quality rating may include determining at least two of a time in business, a credit score, a lien position, a participation amount and an investment default rate. Determining an investment quality rating may include determining at least two of a time in business, a credit score, a lien position, a participation amount and an investment default rate. When the plurality of investor devices does not reach a goal, inviting investor devices with a second criteria set. Determining the investor participation amount may include determining the investor participation amount based on the requested investment amount, a buy rate and a sell rate. The method may include displaying participating investors on a screen display. Associating the criteria set may include associating the criteria set from a plurality of criteria sets with each of the investor devices. The method may include sorting the investor devices in the queue by a rating of investor characteristics. The rating of investor characteristics may include an internal rate of return. The rating of investor characteristics may include cash flows and dates that correspond to the cash flows. The plurality of criteria sets may include a plurality of rules. The plurality of rules may include boundaries, qualifiers and conditions. The plurality of rules based on at least three of minimum funder participation percentage, a maximum percentage per investment, a credit score, a time in business, a minimum term, a maximum term, a lien position, a minimum factor rate, a maximum factor, a maximum commission, a minimum investment size, a maximum investment size, a state, an advance type and an industry or industries. Implementations of the described techniques may include hardware, a method or process, or computer software on a computer-accessible medium.

One general aspect includes a system for allocating investors to an investment. The system also includes a system administration controller; Other embodiments of this aspect include corresponding computer systems, apparatus, and computer programs recorded on one or more computer storage devices, each configured to perform the actions of the methods.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagrammatic view of the investing system of the present disclosure.

FIGS. 2A and 2B are a block diagrammatic view of the system administrator controller.

FIG. 3 is a block diagrammatic view of the originator controller.

FIG. 4 is a block diagrammatic view of the investor controller.

FIGS. 5A and 5B are a high-level system flow for the investment.

FIGS. 6A and 6B are a block diagrammatic flow of the payback process.

FIGS. 7A and 7B are a flowchart of a method for funding of an investment.

FIGS. 8A and 8B are continuing flowcharts of a method for auto matching an investor to an investment.

FIG. 9A is a screen display of an investor portfolio illustrating an investment summary, wallets and balance and an offerings and subscription portion.

FIG. 9B is a screen display for a fund transfer.

FIG. 9C is a screen display for a promissory note signature page.

FIG. 9D is a screen display for a summary of transferring funds.

FIG. 9E is a screen display for an investment summary screen display.

FIG. 9F is a screen display for an offering.

FIG. 9G is a screen display for creating a filter set.

FIG. 9H is a continuing screen display of FIG. 9G with different data therein.

FIG. 9I is a screen display of account data.

FIG. 9J is a screen display for entering bank account data.

FIG. 9K is a screen display for changing the notification settings.

FIG. 9L is a screen display for an originator entering data into the system.

FIG. 9M is a screen display for submitting a new investment.

FIG. 10A is a screen display for establishing conditions.

FIG. 10B is a screen displaying that illustrates further conditions.

FIG. 10C is a screen display showing various merchant or originator data that maybe selected for an investment.

FIG. 10D is a screen display for building rules for an investor.

FIG. 11 is a flowchart of a method for accepting an offer.

FIG. 12A is a screen display for creating new investment criteria.

FIG. 12B is a screen display having further data from FIG. 12A.

FIG. 12C is a screen display for entering various investment data.

FIG. 12D is a screen display with advanced filters therein for selection.

FIG. 12E is a further example of an advanced filter screen display.

FIG. 13 is a screen display illustrating participation for an investment for use by the administrator.

Corresponding reference numerals indicate corresponding parts throughout the several views of the drawings.

### DETAILED DESCRIPTION

Example embodiments will now be described more fully with reference to the accompanying drawings. The following description is merely exemplary in nature and is not intended to limit the present disclosure, application, or uses. For purposes of clarity, the same reference numbers are used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical OR. Steps within a method may be executed in different order without altering the principles of the present disclosure.

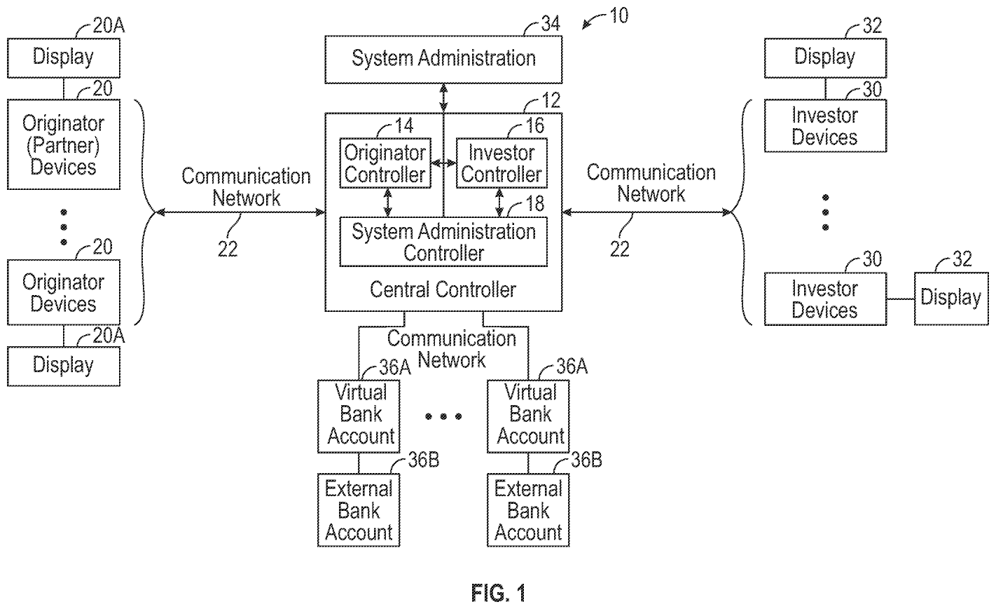

Referring now to FIG. 1, a high-level block diagrammatic view an investing system 10 for allocating investors to an investment may comprise a central controller 12. The central controller 12 may be microprocessor-based and comprise a plurality of microprocessor-based controllers or processors therein. The controllers illustrated in the central controller 12 may be embodied in one or more servers. The central controller 12 may not be present within a system whereby each of the controllers therein may intercommunicate.

The central controller 12, for example, may include an originator or originator controller 14, an investor controller 16 and a system administration controller. A physical central controller may not exist but rather the group of the originator controller 14, the investor controller 16 and the system administration controller 18 may be referred to collectively as the central controller 12. The originator controller 20 is in communication with a plurality of originator devices 20 that are in communication with the originator controller 14 through a communication network 22. The originator controller 20 may have various function some of which may be performed withing the originator device 20. The originator device 20 may be a mobile device such as a portable computer, tablet, or mobile phone. The originator device 20 may generate graphical user display or interface on a display 20A and prompts for entering investment data. The display 20A may be a touch screen. The device 20 may also include a user interface such as a keyboard, mouse, stylus or the like for inputting data The implementation of the methods set forth herein may be provided in an application on the originator device 20 or through a website that facilitates communications.

The investor controller 16 is in communication with a plurality of investor devices 30 through the communication network 22. The devices 30 may have a display 32 associated therewith. The type of devices 30 and displays 32 may be the same as used in the originator devices 20.

A system administrator 34 is in communication with the system administration controller 18. The system administrator 24 may be a human inputting data and supervising the system or an automated system. Artificial intelligence may also be used in a supervisory and data inputting manner. The originator controller 14, the investor controller 16, and the system administration controller 18 all intercommunicate to control the various aspects of the system including matching an investor with a merchant cash advance. Intercommunication may take place through the secured communication network 22 or direct connection. The central controller 12 and/or the controllers 14-18 therein are in communication with a plurality of bank accounts 36A, 36B that are associated with the originators or requestors, the investor and the system administrator.

In general, an originator or originator device 20 sets up an account with the system administration controller 18 to enable the originator to request a merchant cash advance. While a merchant cash advance is used in the present example, other types of financial transactions where criteria sets of investors are matched with an investment. are contemplated. The investment amount of money requested may be referred to as an offering that is offered to investors at the investor devices 30. The originator bank account and other investment data are associated with the investment. The investors also establish accounts and generate a criteria set that is ultimately compared to the investment data. Investors may create multiple criteria sets so that a diversity of investments is achieved. Multiple investors may then be invited to invest in the investment. When a criterial set is matched with the investment data, the requested amount is then transferred to the account of the originator and the investors are paid back by the originator over the specified period of time.

The investor or the device 30 used by the investor is in communication with the central controller 12 and potentially the system administrator 34 to set up an account for investing in various merchant cash advances. The central controller 12, if one is used, and, more specifically, the system administration controller 18 may establish virtual bank accounts 36A (VBs). The originators and investors may have the VBs 36A associated with an external bank account 36B external to and linked to the virtual bank accounts 36A. The system administration controller 18 may control the interactions between the virtual and external bank accounts.

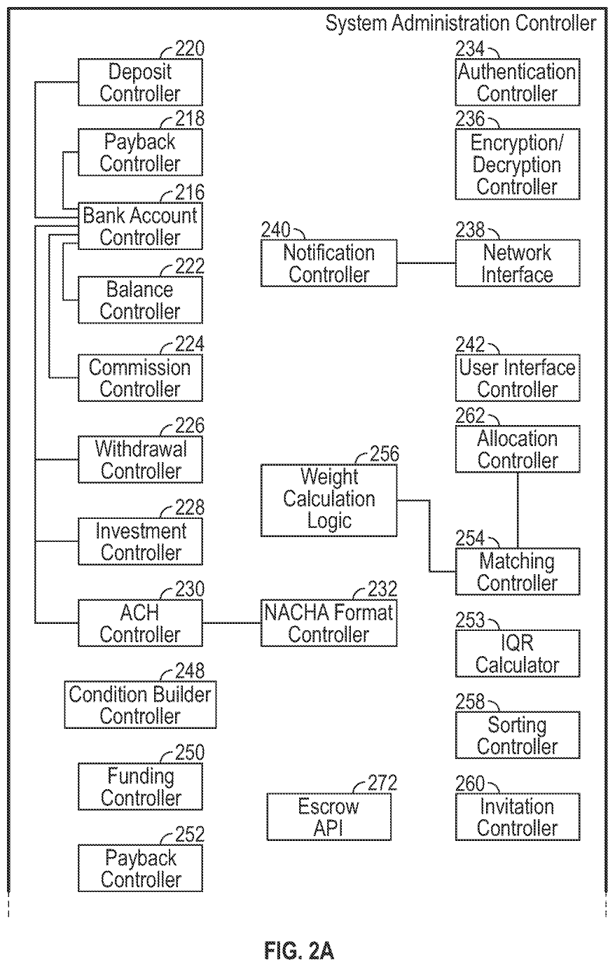

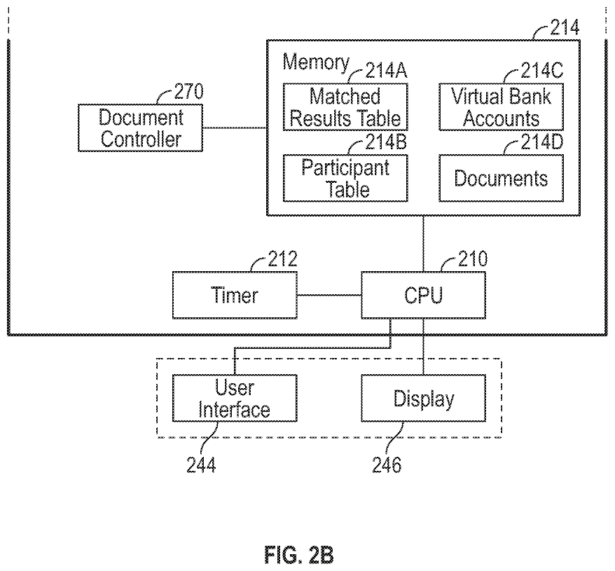

Referring now to FIGS. 2A and 2B, the system administration controller 34 is set forth in further detail. In general, the system administration controller 34 controls the matching of investors to originators as well as various administrative functions that may include but not limited to establishing accounts for both investors and originators, establishing a virtual bank account for investors and originators, determining various conditions and keeping track of various deposits and paybacks into the partner/originator's and investor's accounts.

A central processing unit 210 or a plurality of central processing units are used to control various functions in the system administration controller 18. The central processing unit 210 may be micro-processor based and is programmed to perform various functions performed by the various interfaces and controllers. The central processing unit 210 is coupled to a timer 212 to time various functions including how long an investment is available to an investor before it expires. The central processing unit 210 is associated with a memory 214 that stores various data including intermediate data. The memory 214 may include a match results table 214A, a participant table 214B, a plurality of virtual bank accounts 214C and a documents memory storing various papers including authorization papers for various transactions.

The system administration controller 18 includes a bank account controller 216 that is coupled to a payback controller 218 and a deposit controller 220. The bank account controller 216 may control the virtual bank accounts and generate signals for interacting with external bank accounts. For example, confirmation signals of deposits made, money transferred, and the like may be controlled by the controllers 216-218. The payback controller 218 controls the allocation of money to various investors once the originator pays. The deposit controller 220 controls the deposits from the various investors and directs them to the proper VBs and the proper originator account. A balance controller 222 allows the balance to be displayed to the various parties. A commission controller 224 calculates the commission associated with the transactions and increases or decreases the various balances accordingly. A withdrawal controller 226 controls the withdrawal of money from the various accounts and directs them from the virtual bank account to an external bank account. An investment controller 228 controls the movement of funds in an investment to an offering.

An automated clearinghouse (ACH) controller 230 controls the communication of funds to and from external bank accounts. The formalities and authentication of the ACH process are specifically complied with in the ACH controller 230. More specifically, a national automated clearinghouse association (NACA) controller 232 coupled to the ACH controller 230 may be used to format the deposits and withdrawals through the ACH controller 230.

The system administration controller 18 may also include an authentication controller 234 that controls the authentication of the originators and investors when communicating with the system administration controller 18. An encryption/decryption controller 236 controls encryption and decryption between the originator devices and the controller as well as between the controller and the investor devices.

A network interface 238 controls the communication through the various types of communication networks. The communication networks may be wired or wireless, communication networks that use encryption and decryption for secure communications therethrough. A notification controller 240 is coupled to the network interface 238. Various types of notifications may be communicated to the investors and the originators. For example, notifications may be generated when an investment status changes, when the collected amount changes, when investment amount limit changes or when the user's password changes. Various types of notifications may be generated including an email, a voice call, an application notification or a text message.

A user interface controller 242 controls the interaction of the system administration controller with a user interface 244 and display 246 coupled to the CPU 210. User interface screen display are generated by the user interface controller 242 for performing various functions of the system administration controller 18 are described below.

A condition builder controller 248 provides conditions against which an investment may be selected. The condition builder controller 248 generates establishes criteria sets which comprises the conditions against which an investment will be selected for an investor. In some examples, each individual condition may be selected for through discussion with an investor or selected by an investor using a user interface and a screen display as is illustrated below. In other examples, certain pre-formed criteria groups may be established by the system administrator or saved by an investor so that a criteria set may be easily selected without having to pick each condition individually.

A funding controller 250 and a payback controller 252 control the funding and payback to the originator devices and therefore control the flow of money from the investors to the originators and the originators to the investors. Funding an investment may involve selecting an initial group of investors (having a group size) with reserve group, setting a time period limit for acceptance by each investor and generating a query signal to investors on the reserve list should one of the investors in the initial group decline acceptance.

During the process, an investor quality rating (IQR) calculator 253 may be calculated prior to the selection and used as the investment data or part of the investment data. Investors for a particular merchant cash advance or other investment may be matched based on the IRQ and or other investment data. Prior to the matching, an investor quality rating calculator determines an investor quality for the merchant cash advance or other investment.

A matching controller 254 matches the criteria set for the investor devices to investment data such as various investments set forth by originators to form the initial group and pick alternate or reserve investor devices. Merchant cash advances or other investment examples have investment data that are compared by the system administrator to the criteria sets of the investors. Weight calculation logic 256 may be used to weight certain filter terms or criteria of the criteria set to form the match. Weighting may be controlled by the system administration controller 18. Likewise, an investor may control the weighting. Ultimately, various matching criteria sets are sorted by the matching controller 254 and are stored within the matched results table 214A in the memory 214.

A sorting controller 258 sorts the matching investors and provides an invitation through the invitation controller 260.

An allocation controller 262 is shown as a separate item but may be part of the matching controller 254 and sorting controller 258. Ultimately, the number of investors and the amount of investment allocated to each investor based upon the sorting controller 258 and thereafter an invitation from the invitation controller 260 may be communicated to the various investors for accepting within a particular time period. The allocation controller factors in commission in the investment process so that the total investment plus the commission is obtained from the investors.

The invitation controller 260 may send further invitations to other investors should an invitation be declined. The list of participating investors is determined with the matching and invitation process. Ultimately, the list of participating investors is stored in the participation table.

A document controller 270 may control the signing and verification of documents to obtain a merchant cash advance or investment offerings and used for authorizing the various investments. The documents may be stored within the documents memory 214D of the system administration controller 18.

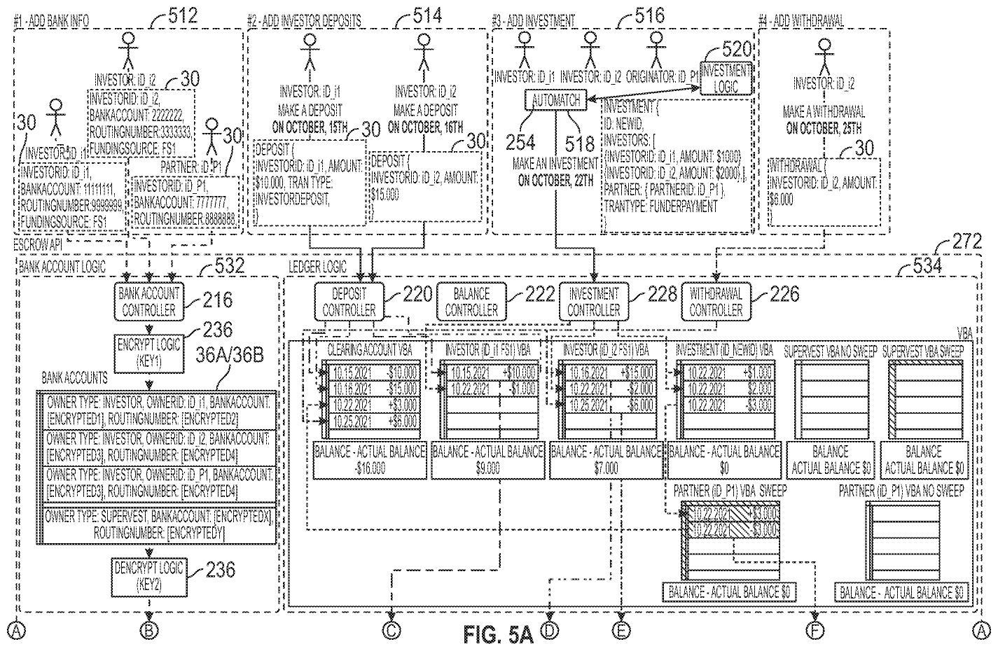

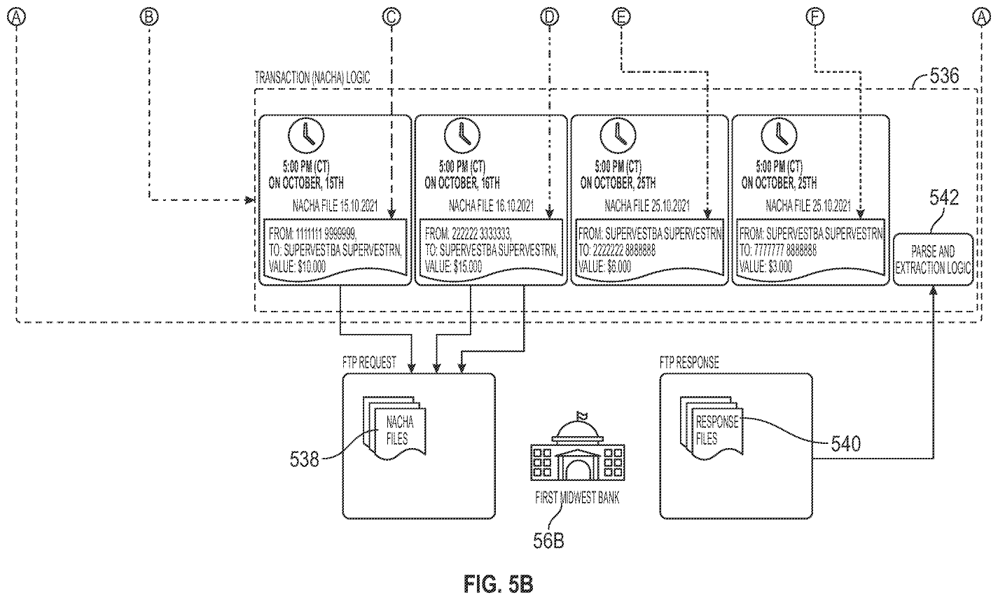

An escrow API 272 may act as an interface to the various controllers within the system administration controller 18 and the originator devices 20 and investor devices 30. The escrow API 272 is described in further detail in FIGS. 5A and 5B.

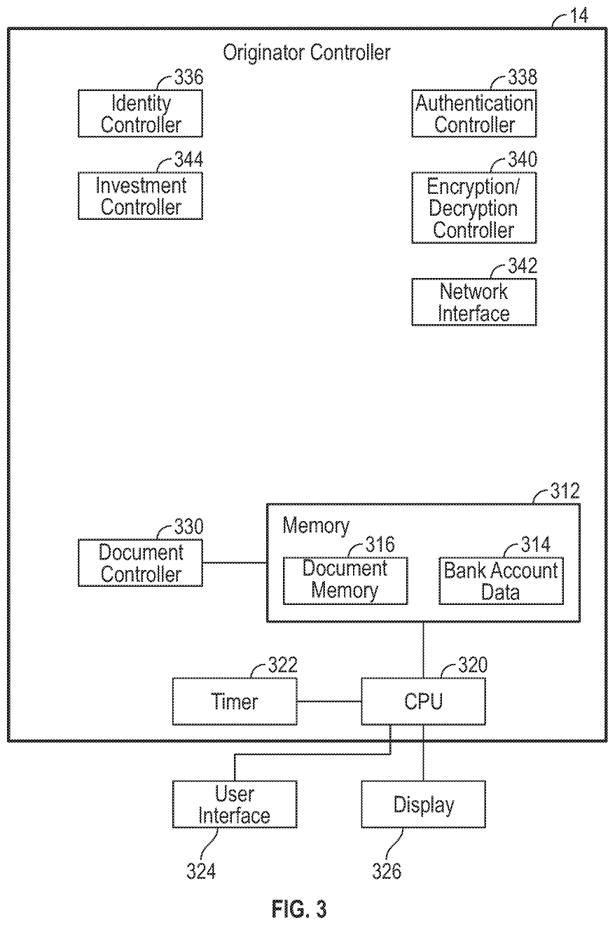

Referring now to FIG. 3, the originator controller 14 is provided in further detail. The originator controller 14 is illustrated within the central controller 12 but may also be incorporated within one of the originator devices in FIG. 1, or both. That is, an investment may be established by an originator which is ultimately approved by the system administrator 34. Further, the investment may also be entered into the system by the system administrator 24 by interaction with the originator. The originator controller 14 may have various blocks including a memory 312 that stores bank account data in bank account data memory 314 and a document memory 316 storing documents therein. A CPU 320, a timer 322, a user interface 324 and a display 326 may all be similar to that set forth with respect to the system administration controller 18 in terms of enabling inputting, changing and displaying data. The CPU 320 generates and receives the signals for obtaining the various data. Likewise, the document controller 330 may also be similar and used for an originator to sign various documents which may ultimately be stored within the document memory.

The originator controller 14 may also include an identity controller 336 that has various identity data stored therein. The identity controller 336 generate prompts for an originator or system administrator 34 to enter data about the originator (originator identifier, PIN and the like) and may also provide input for an authentication controller 338. An encryption/decryption controller 340 may be included within the originator controller 14 for controlling encryption and decryption when communicating through a network interface 342. An investment controller 344 controls the entry of various types of investment data and communicates the investment to the system administration controller 18 though the network interface 342. The investment data for a merchant cash advance (or other investment) may include but is not limited to a merchant investment identifier (such as number/alphanumeric identifier), a total merchant funding amount, a funder participation dollar amount, a funder participation percentage amount, a participation dollar requested amount, a participation percent requested amount, various advance types which may include a new investment, a renewal investment or an add-on investment. Other investment data may include the type of repayment method such as ACH, a lien position, a buy rate and a sell rate, commission points, management fees, the repayment frequency, the number of payments, the term in months, the payment amount, the average daily receivables, and the total remittance percentage. Of course, other types of data for generating and offering may be provided by the originator.

Other identifiers may be stored or entered through the identity controller 336 such as the merchant's name, the merchant EIN, the merchant DBA, the merchant website, the merchant postal or ZIP code, the industry, the incorporation date, the time in business, the owner's FICO score, the FICO range over a period of time and gross monthly revenue. Ultimately, documents may be submitted to, for example, generate a promissory note.

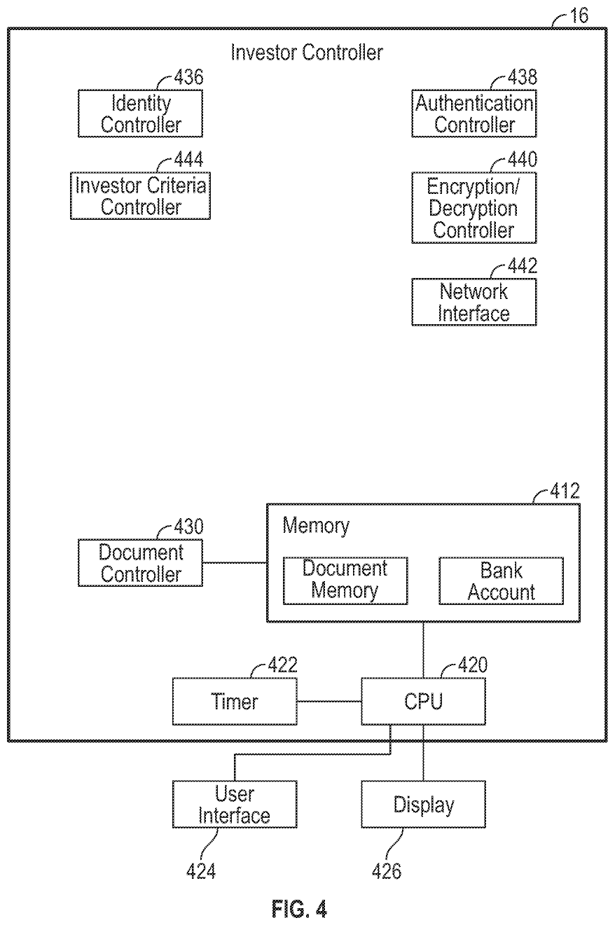

Referring now to FIG. 4, an investor controller 16 is illustrated. The investor controller 16 may be located within the controller in FIG. 1 or within one of the investor devices 30 of FIG. 1, or both. It should be noted that the investor devices 30 and the originator devices 20 may be various types of devices such as a desktop computer, laptops, telephones, tablets, wearables and the like.

The investor controller 16 may have various similar functions as the originator controller 14 such as a CPU 420, a timer 422, a user interface 424, a display 426, a memory 412 and a document controller 430. These items act in a similar manner to that described above with data specific to the investor making investments.

The investor controller 16 may also have an identity controller 436 that may provide the identity and identifying information to the system 10. An authentication controller 438, an encryption/decryption controller 440 and a network interface 442 may also be used and perform step and functions similar to the above. An investor criteria controller 444 may allow the investor to enter various criteria of a criteria set that are agreeable to the investor. For example, the investor may enter various data for consideration such as the partner itself, the partner default rate, the commission or points, the average daily receivables, the participation requested, the funder participation, the total payback amount, the term in months, the lien position, the buy rate, the sell rate, the partner management fee, the merchant gross monthly revenue, the merchant time in business, the merchant EIN, the merchant FICO data, the merchant industry data, an advance type and the merchant state. Various types of limits, such as above or greater than, less or the like, may be provided and not and or may be used to link several different criteria for the investor to consider. The criteria set may be set up at the investor device or may be set up within the controller. The investor criteria input through the investment controller 16 may be used in determining the IQR and within the matching controller for allocating various investors to an investment.

Referring now to FIGS. 5A and 5B, an escrow management application programming interface (API) 510 is set forth. The escrow management API 510 shows the investment flow for the investor adding bank account information in block 512 and investor deposits in block 514. Originators add various investments with investment data and investors add criteria sets in block 516. Auto matching logic 518 matches the investors to the investments as described in more detail below. The investment logic 520 is used to obtain the investment data.

Escrow logic 272 controls the interaction of the high-level components of the system such as the back account logic 532, the ledger logic 534 and the transaction logic 536. Bank account logic block 532 controls the bank account controller 216, the encryption/decryption logic 236 relative to the VBs 36A and the regular bank accounts 36B.

Ledger logic 534 is used to control the interaction of the investor devices 30, the originator devices 20 and the escrow API 272, which may be for the deposit controller 220, the balance controller 222, the investment controller 224 and a withdrawal controller 226.

The escrow API 272 may also include transaction (NACHA) logic 536. The system may generate various transactions through the transaction logic 536 for processing various ACH transactions. For example, external banks with external bank accounts 56B may receive NACHA files 538 through FTP. Likewise, FTP may be used to communicate response files 540 to parse and extraction logic 542 of the transaction logic 536. In FIGS. 5A and 5B the escrow management is performed. That is, escrow deposits are established by the investors and used to fund the offerings by the originators.

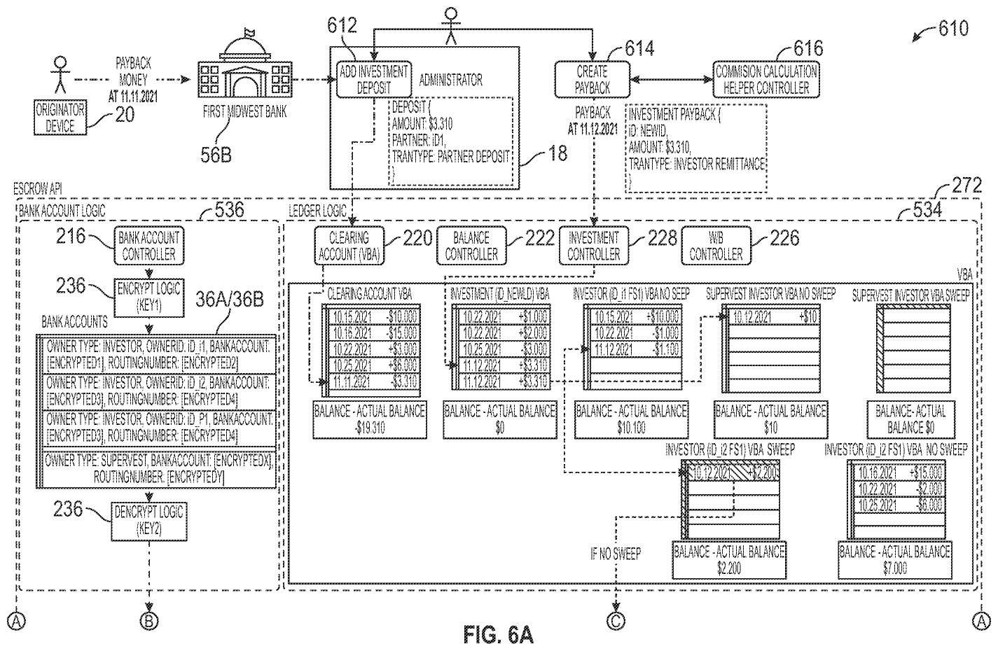

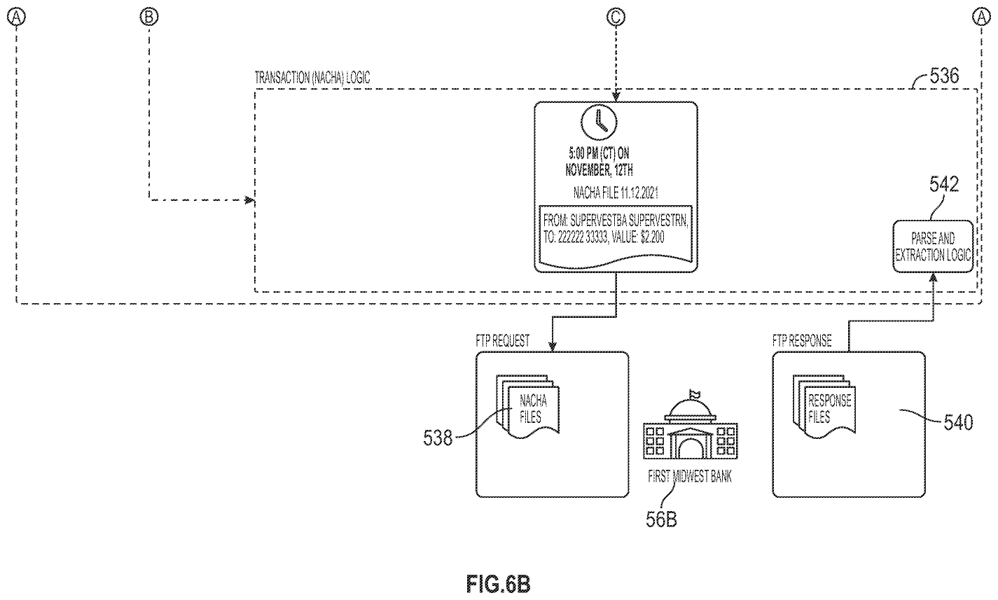

Referring now to FIGS. 6A and 6B, the payback flow logic 610 is illustrated in block diagrammatic form. The payback logic 610 illustrated the payment from the originator to the investors over time. The originator device 20 communicates money to the bank account 56A and or bank account 56B. The system administration controller 18 adds investment deposit in block 612 to the deposit controller 220. The bank account controller is illustrated in bank account logic 536. Ledger logic 534, such as the deposit controller 220, the balance controller 222, the investment controller 228, and withdrawal controller 226 are illustrated. The bank account logic 536 and the ledger logic 534 are coupled to the transaction logic 536 which may perform the transaction to a bank or bank accounts using NACHA files by generating FTP (file transfer protocol) request and file transfer protocol responses.

The system administration controller 18 creates payback in payback block 614 which communicates the payback signal with a payback amount as data to the investment controller 228. The appropriate investor account may be credited accordingly minus commission, if appropriate.

A commission calculation controller 616 determines the commission and retains the commission for the transaction system. The transaction system company bank account may be credited accordingly.

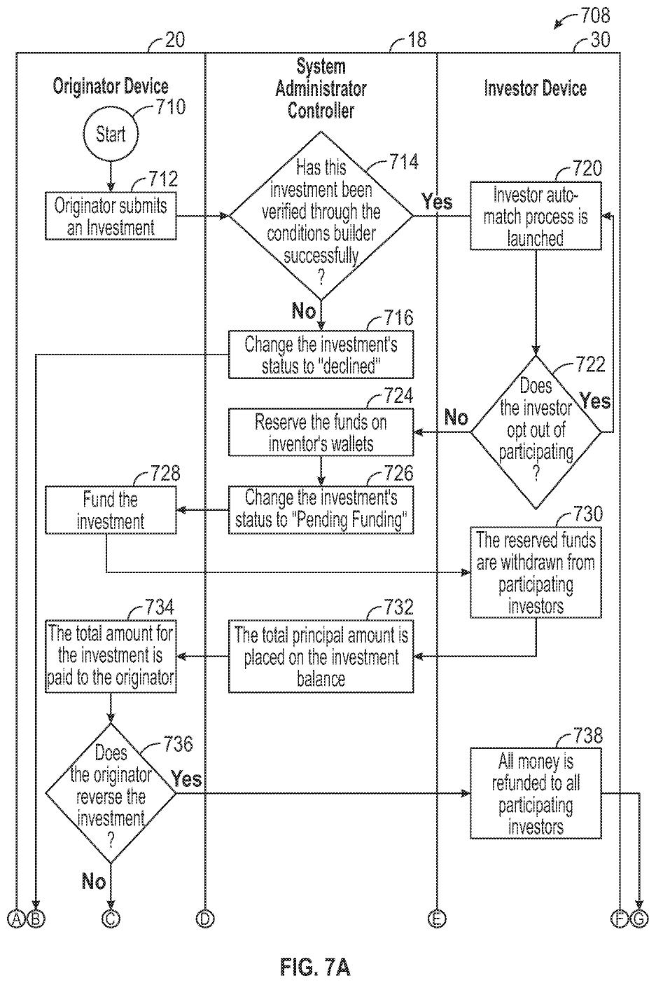

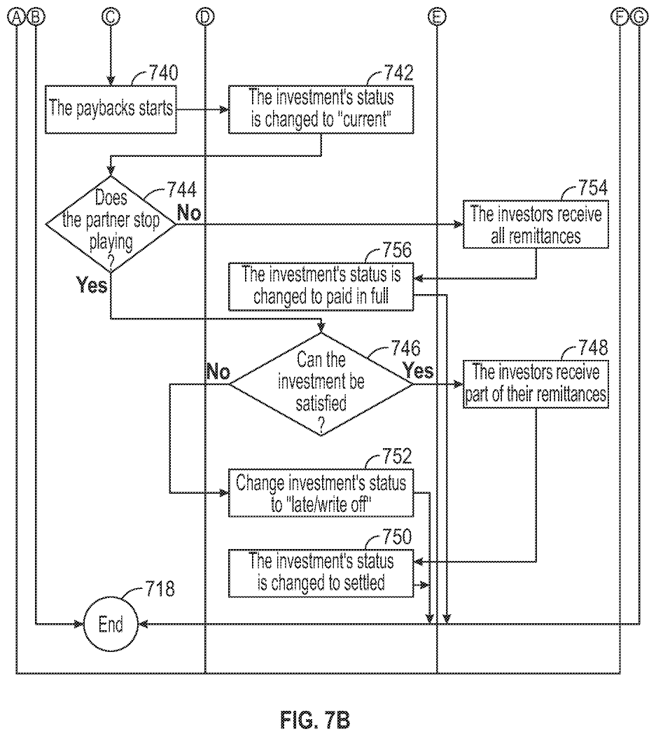

FIGS. 7A ND 7b are a flowchart of a method for performing a merchant cash advance and sets forth columns corresponding to the system administrator 18, a partner or originator device 20, and an investor device 30 illustrating which devices perform the function. A process 708 for managing an investment such as merchant cash advance is set forth. In step 710, the system starts. In step 712, the originator submits an investment. The originator submits an investment through the originator device 20 by communicating data signals corresponding to various aspects of the investment. Interaction with the originator by the system controller 18 is controlled at the originator controller 14 described above. The investment controller 288 of FIGS. 2A and 2B may control the interaction with the originator device to obtain the investment data for the investment.

In step 714, the investment may be verified through the condition builder controller 248 of the system administration controller. Depending upon the type of investment, various checks may be performed. Checks for missing data may also be performed before it is offered to an investor. After step 714, if the condition builder controller has not verified by the investment, step 716 changes the investment status to declined and the system ends in step 718.

Referring back to step 714, when the investment has been successfully verified, step 720 performs an auto matching process with the investors. As mentioned above, the investors generate criteria sets that are compared to the investment data to determine if there is a correlation. The auto match process generates a list and a reserve list of investors for the investment. The auto match process is described in greater detail below.

After step 720, step 722 determines whether the investor opts out of participating. If the investor opts out of participating, step 720 may be performed in which a new investor is invited to the investment. After step 722, step 724 reserves the funds on the investor's wallet. That is, the investor wallet is a virtual bank account set up by the system administration controller 18 should the investment be successful ultimately the money will be transferred to the originator. After step 724, step 726 changes the investment status to “pending funding”. After step 726, step 728 funds the investment when all of the investors together have provided enough funds for the investment plus the commission. In step 730, the reserve funds are withdrawn from the bank accounts of the participating investors. In step 732, the total principal amount is placed on the investment balance. The commission is provided to the system administration. In step 734, the total amount for the investment is paid to the originator. That is, a communication between the system administration controller 18 and the originator device 20 allows the investment amount to be transferred to the originator bank account. In step 736, it is determined whether the originator has reversed the investment. If the originator has reversed the investment, step 738 refunds the investment allocated from each investor device to the investor. That is, a communication signal is communicated from the originator to the system administration controller 18 which controls the movement of money to the investor. The money is refunded to all of the participating investors and the system then ends in step 718.

Referring back to step 736, when the originator does not reverse the investment, payback from the originator to the investors begins in step 740. The term of the payback and the amount of the payback may vary depending upon the investment and then investment data provided by the originator. Ultimately, the system administrator controller may allow or disallow or change the values of various aspects of an investment prior to offering the investment to the investors. In step 742, the system administration controller 18 changes the investment status to “Current” when the payback is being performed by the originator on time. After step 742, step 744 continues checks whether the partner has stopped paying. If the partner has stopped paying step 744, step 746 determines whether the investment can be settled. If the investment can be settled in step 746, step 748 allows the investors and the investor devices 30 to receive part of the remittances. This is performed by the balance controller 222 moving funds between the associated bank accounts. After step 748, step 750 changes the investment status to “Settled”. Referring back to step 746, if the investment cannot be settled, step 742 changes the investment status to “Late” or “Write-off”. After steps 750 and 752, the system ends in step 718.

Referring back to step 744, when the partner does not stop paying, all investors receive all remittances in step 754. After step 754, the system administration controller changes the investment status to “Paid in Full” in step 756. After step 756, the system ends in step 718.

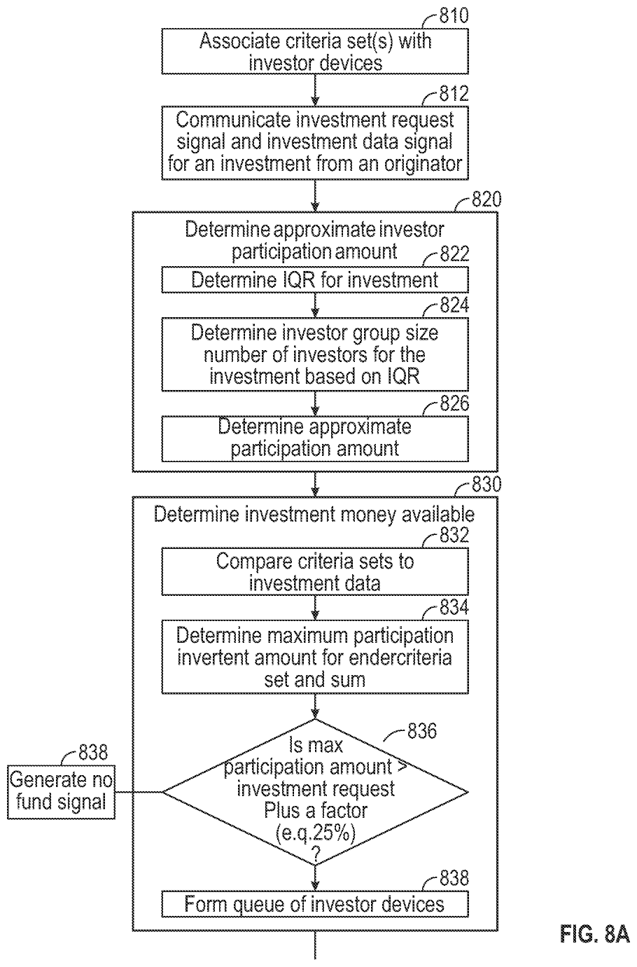

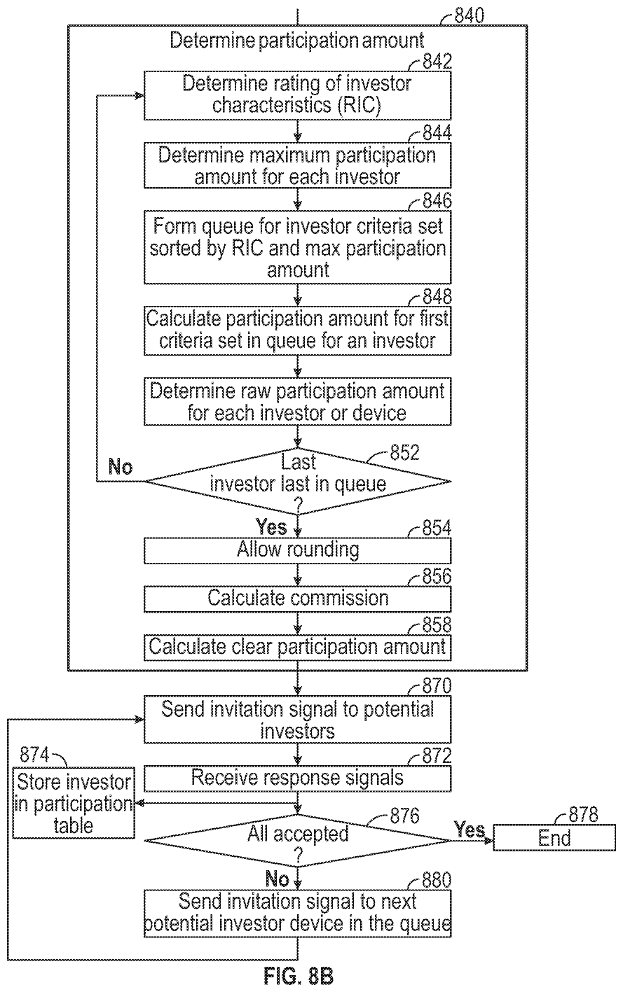

Referring now to FIGS. 8A and 8B, a flowchart of the auto matching process of step 720 above is set forth. Auto matching process launches once an investment is submitted. It takes into account investment quality rating, investors' criteria sets and the investors balances as well as some other parameters. As mentioned above, the originator may provide various investment data for the investment to allow the system to allow automated matching of investments for consideration by the investors. The investment data was mentioned earlier and is entered using a user interface as set forth below. In step 810, a criteria set or sets are associated with the investor. The criteria or conditions within the criteria set may be weighted by the system administrator or weighted by the investor. As mentioned above, multiple investment selection data form a filter set (rule data having condition data and boundary data) that may be entered by the user and allows the input of various boundary ranges, and qualifiers such as greater than or less, and AND, OR and NOT (and combinations thereof) that may be related to the investor data.

In step 812 an investment request signal and investment data are communicated in an investment data signal to the system administration controller 18. The investment request signal has various the investment data including to the requested investment amount. Various types of investment data are entered.

A general step 820 determines approximate investor participation amount for the investment. Step 820 has several sub-steps including step 822 which determines the Investment Quality Rating (IQR) of the investment. IQR is an investment rating, which may be based on the following set of indicators, and indicates the level of attractiveness of this investment for potential investors:

For the originator, IQR factors may include more than one of (but are not limited to): presence/absence of history within the platform, assessment of the quality of this history (if it is present), time in business, FICO (credit rating, the higher it is, the better it is), industry (rating of the riskiness of industries), lien position (number in the queue to receive money in case of merchant bankruptcy. The higher the lien position is, the less desirable it is.

For an investor, IQR factors may include: the percentage of the partner's participation in the deal, the history of acceptances of invitations for participation in the investments of this partner, the investment default rate, the history of payments on the partner's investments is based on the status of his investments.

For an investor, IQR priority may go to the investor with the worst payout history. (|RTR-IRR|).

Based on the IQR, the system calculates optimal or desired number of investors for the investment is determined in step 824. That is, an investor group size of investor devices is determined. A table with optimum number of investors or investor devices based on the participation money available is generated. The system administration controller 18 takes the optimal number (desired investor group size) and the acceptable deviation from a table that is precalculated based on various factors specific to the lending practice associated with the system, originators and investors. The deviation is used as a reserve list.

The desired or optimal investor group size=Optimal (desired) Number+(if IQR>=0.5 then (−1), otherwise 1)*Deviation*IQR).

If optimal (desired) investor group size<=0, then optimal (desired) number of investors=1.

In step 826, based on the optimal number of investors, the approximate participation amount including commission is calculated (aka approximate raw participation amount) by:

approximate raw participation amount=(requested amount/optimal number of investors)*(1+(buy rate−sell rate))

In step 830 the investment money available is determined by the sub-steps therein. In step 832 all the investors or investor devices with all criteria sets are collected and compared to the investment data including the IRQ to determine which criteria set or sets are suitable for the investment. The system may exclude a criteria set if there is less money on the Offering Balance than minimum per deal. At this stage, the system administration controller 18 may also check all the criteria except participation amount in the criteria set. There may be duplicate investors in the queue list. That is, an investor may have several criteria sets.

In step 834 the maximum participation investment amount for each criteria set, taking into account the maximum per deal, max investment per month and offering balance.

In step 836 the total max participation amount for all criteria sets is compared with the investment requested amount. If the total max participation mount is greater than 25% of the monetary value plus the value available from the optimal number of investors for this investment, then the logic understands that there is enough money for the investment to cover the investment, commissions and refusals to invest. If not step, 838 generates a no fund signal.

After step 836 is positive, step 840 and the sub-steps therein determine the participation amount for each potential investor at the allocation controller 222 of the system administration controller 18. A queue of investor devices is formed in step 838 of all of the investor devices for a criteria set for which enough investment money is available from step 836. Some investor devices may have more than one criteria set and therefor they may be differentiated in the queue by the different criteria sets.

In step 842, a Rating of Investor Characteristics (RIC) is determined for each of the investor devices in the queue. RIC is a calculated rating, according to which investors are prioritized in the process of the auto-matching process. This is calculated based on the extended internal rate of return (XIRR).

RIC=(1000+XIRR)*FactorMultiplier where FactorMultiplier=1 for investor and FactorMultiplier=100 for the Note.

In step 844, the maximum participation amount for each investor is determined. The greater the RIC and max participation amount, the more likely the investor is to become an investor in the particular investment.

XIRR=XIRR(values,dates,[guess])

The values are cash flows, the dates are the dates that correspond to cash flows and guess is an estimate for expected IRR=0.5 (of course various values may be used).

Based on the RIC the queue is sorted and a participation amount for the first criteria set in the investor queue is determined in step 846.

In step 848 the criteria sets are used to determine the investment amounts for different the criteria sets from the queue. The first criteria set (and subsequent criteria sets during a loop) is retrieved and its raw participation amount (including commission) is, when there is enough money in the system in step 830, determined by: raw participation amount=min(max participation amount; remaining amount; approximate (investor or offering) raw participation amount)

For the investor: The investor approximate raw participation amount=investment requested amount (without commission)/optimal number of investors.

For the originator: Offering approximate raw participation amount=investment requested amount (without commission)*admin offering %

For the Investor/Offering, the approximate raw participation amount=Max(minPerDeal, Investor/Offering approximate raw participation amount)

Remaining Amount=investment requested amount (without commission)−already collected amount from previous loops through the loop

border=2000 (or another number by design): a condition ((investment requested amount>=border and Remaining Amount−Investor/Offering approximate raw participation*1.5<125) OR (investment requested amount<border and remaining amount-investor/offering approximate raw participation<25)),

If the condition is true then: Investor/Offering approximate raw participation amount=Remaining Amount*(1+commission %);

If the condition is false then: Investor/Offering approximate raw participation amount=Remaining Amount*(1+commission %).

If there is not enough participation amount (plus the factor if any) in step 836, then raw participation amount=min (max participation amount; remaining amount)

If raw participation amount<min per deal then participation amount=0.

If the remaining amount−the raw participation amount<25, reduce the raw participation so that remaining amount−raw participation amount=25, if 25 does not contradict the minimum per deal of this criteria set, otherwise leave raw participation as is.

In step 852 a check whether the investor is the last in the queue. If yes, in step 852, step 854 the system allows pennies and rounds up to 2 decimal places.

In step 856 the commission is calculated Calculate participation amount without commission (clear participation amount)=raw participation amount/(1+commision %).

If already collected amount+clear participation amount=investment requested amount then the criteria is the last. In step 858 calculate a clear participation amount as: clear participation amount=raw participation amount/(1+commision %).

If this participation is NOT the last then the clear participation amount=[clear participation amount/25] *25; Calculate commission amount=clear participation amount*commission %.

If clear participation amount<=0 then exclude this participation.

If the participation amount is >0, go to the list of criteria sets, find all the criteria sets with this offering subscription and exclude them.

The above method has focused on determining potential investors. An affirmative approval from the investor is needed to make the potential invest and actual investor who pays money to the originator. An invitation signal is sent to the potential investor in step 870, that asks for approval of an investment as a participation confirmation signal. In step 872, the investment is received, and the response signal is generated corresponding to the investment being accepted or declined by the various investors. Specifically, step 872 determines whether a response signal is received. Ultimately, a participant table or list is stored in the memory of the administration controller in step 874. Only investors that accept the investment are changed to investor from potential investors for the investment.

In step 876 it is determined whether all the invitations are accepted. If all the invitations are accepted the system end the auto matching process in step 878 In step 876 when any of the invitations are decline, another potential investor is determined from the queue (or the reserve portion of the queue in step 880.

After step 880, step 870 is repeated. The auto-matching process is completed when the investment reaches the funding goal (plus fees and commissions).

A Matching Results Table 214A (of FIGS. 2A and 2B) displays the log of all the investors who have been evaluated during the auto-match process by the system and either added to the investment (matched) or excluded from it based on some parameters. This may be displayed to the system administrator.

The following information should be available in this table 214A may include: Investor Name and Auto-Match Result (matched/excluded). If excluded: the reason why the investor has been excluded from the investment (e.g., investor's activity rating at the moment when he/she was matched and the explanation which parameters used to calculate that rating didn't allow to match the investor, investor cash balance etc.)

If matched, the current participation status (pending/accepted/declined) and the proposed share.

A participation tab or table 214B of FIGS. 2A and 2B displays only those investors whose participation status is accepted. Once the partner or originator submits the investment and auto-match process is launched, no information is available in the “Participation” Tab or table. When the auto-match process is over, all those investors whose participation status is “accepted” are displayed in this tab.

The system administrator can update the principal participation requested amount as well as participation of each individual investor in “Participation” table. “Participation” tab is not available for editing when auto-match process is in progress (launched either automatically or manually). If the system administrator or the partner cancels the investment when auto-match is in progress, the auto-match are stopped.

In general, the number of iterations in the auto-match process should be limited by time (thus, the auto-match process will cease to be discrete and will continue for all the time that is allotted).

The maximum amount that an investor can spend on investment is equal to X=Min(MaxPerDeal, TotalAmountOfAvailableMoney)

A time interval (trading day) may be used during which investors can receive offers.

At the beginning of the auto-match process, there may be an assessment of the total amount of money available to fill in this investment, ideally. If there is not a lot of money in the system and the valuation of the investment is low, then the investment may be rejected immediately.

When creating an investment, the partner must specify a parameter marking the minimum required amount of money that needs to be collected, and if we cannot collect this amount for this investment, even in an ideal scenario, then the investment may be rejected immediately.

The matching controller may contain general matching logic (GML)−the main logic by which the selection of investors for investment will take place in the process of automatic distribution.

During the auto-match, the logic takes all available investors and calculates their additional indicators (weights), according to WCL (Weight Calculation Logic).

All selected investors are stored in a separate collection in the database, then work with this collection is carried out by analogy with a sorted list in descending order.

The system goes through the list of investors in order and compares them against the investor established filter criteria described below and other basic criteria (Max/MinPerDeal, FICO, etc.).

There is a deadline set for the auto-match process based on configuration parameters (for example, 1 hour or ˜2 full iterations)

The system collects the number of investors needed based on the optimal parameters set in the administration panel (for example, for an investment of up to $10,000, there are 5 investors) and send them invitations with an invitation signal. Further, as investors decline investments, the system goes further down the list and tries to refill the investment up to the required amount.

As soon as the time remaining until the end of the auto-match process becomes less than the lifetime of one pending investment (e.g., 30 min), the investment refill logic stops working and the system waits for the replies from the remaining investors whose invitations were sent and are still pending.

As soon as all remaining pending investments (e.g., invitations) are accepted/rejected, the auto-match process can be considered complete.

A notification controller or notification system (NS) is used to notify investors using a notification signal corresponding to a notification of a lien for some amount of money of their cash balance.

An investors per deal distribution model (IPDDM) is a distribution model by which the system will determine the optimal number of potential investors for a deal. The number of investors participating in the investment may directly depend on the rating of the investment. The lower the rating, the more investors are needed for investment to minimize the risks of each individual investor. The investor count is therefore a function of the rating of the investment.

A participation mode (PM) changes the volume of offers for the investor (e.g.: Aggressive, Conservative, etc.). For example, in Aggressive (APM)— a mode in which the investor would have the opportunity to invest all deposited money as quickly and actively as possible on the platform with a minimum of artificial restraints and maximum freedom.

It is possible for an investor to participate in any number of deals with MaxPerDeal until the cash balance runs out.

Conservative participation mode A (CPMA)— a mode in which the system will artificially slow down and stretch the process of investing money for an investor within a month, without giving the opportunity to spend everything at once. The first payment is approximately equal to MaxPerDeal. The rest of MaxPerMonth is divided equally for each day for the rest of the month. The money not spent for the day is added to the limit received the next day.

Conservative participation mode B (CPMB) is a mode in which the system will artificially slow down and stretch the process of investing money by the investor for a month, without giving the opportunity to spend everything at once. There may also be a limitation of deals per day and cumulative accumulation of the number of declined deals.

Individual investor performance (IIP) is the investor's activity level, which serves to determine the degree of participation of a particular investor directly in the process of investing money within the framework of the platform. As part of the auto-match process, this rating may be considered in such a way as to try to stabilize the average of all investors on the platform near a predetermined mark. This is necessary first of all in order to raise the interest of the average investor to bring more money to the platform.

Each action/inaction affects the investor's IIP in one direction or another, for example: How often does he/she make deposits? How often does he/she withdraw money? How often does he/she accept deals/decline them? How much does he/she invest regularly? Priority is given to investors with the lowest IIP, in order to bring all investors to the same IIP level.

Investor Matching Process Logic (IMP) is the process of auto-matching a specific investor to a specific deal. This process is as follows:

The investor was selected during the auto-match as a candidate for a deal.

The selected investor enters the pending state for this deal and is excluded from the further search for investors for this deal.

The amount X with which the investor was selected as a participant in this investment is reserved on the investor's cash balance until the investor declines this deal. The money is finally debited from the account if this offer is accepted (once the investment status is changed to “funded”).

Thus, the system immediately searches for the necessary number of investors to completely close the deal and repeats the iteration if not all offers have been accepted. Weights Calculation Logic (WCL) is logic for calculating investor weights when forming a list of investors for investment. The weights are be divided into two components−the base weight (those parameters that are tied only to the investor and their data)+additional weight (parameters that are tied to the investment criteria in conjunction with a specific investment). The base weight is calculated in advance and stored together with the investor's entity data. The additional weights are calculated when the auto-match process starts. If an investor has several suitable investment criteria, priority are given to the most “advanced” criteria set.

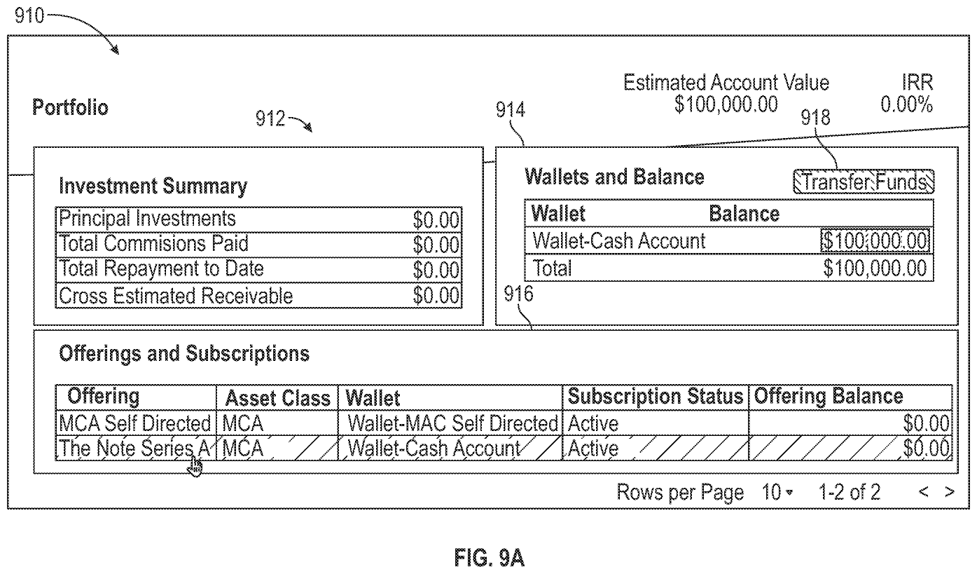

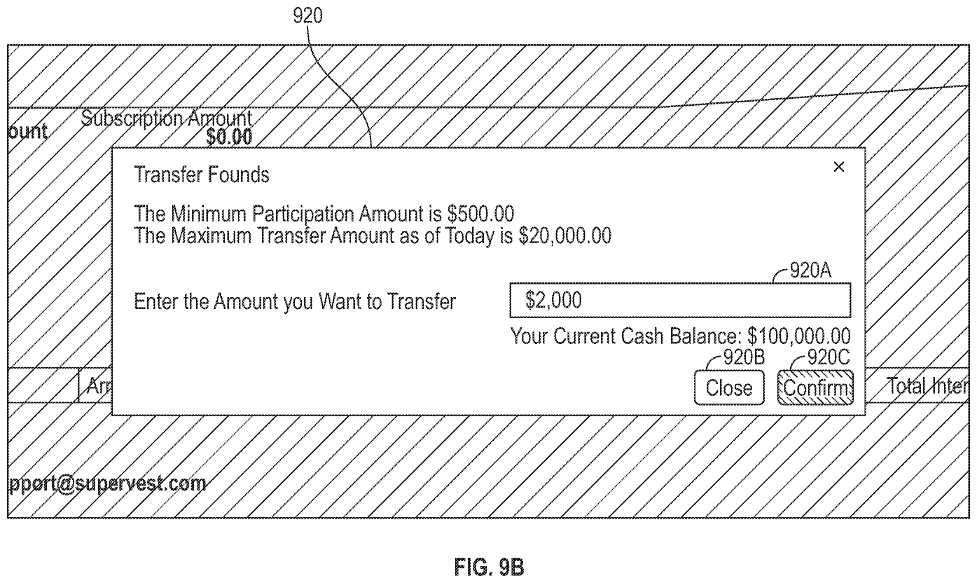

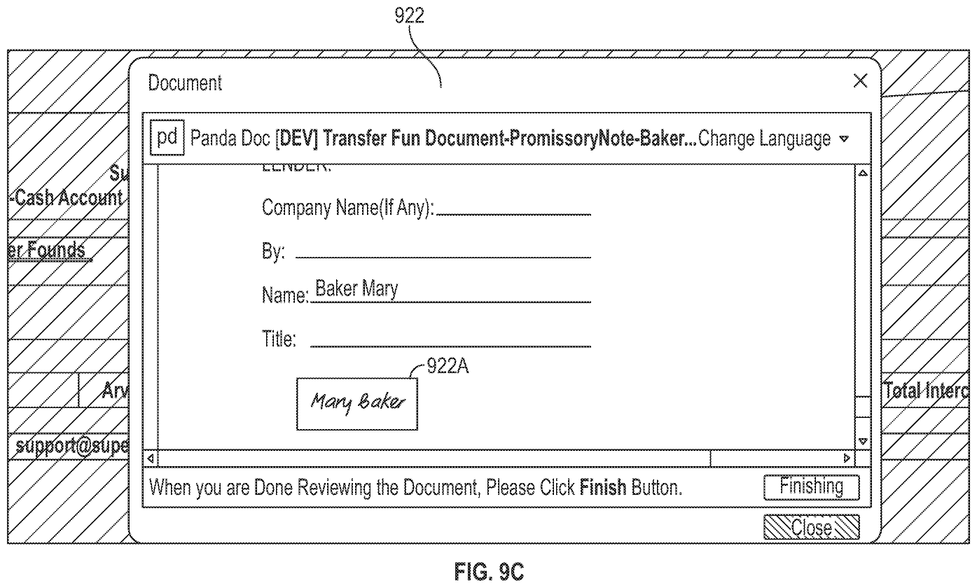

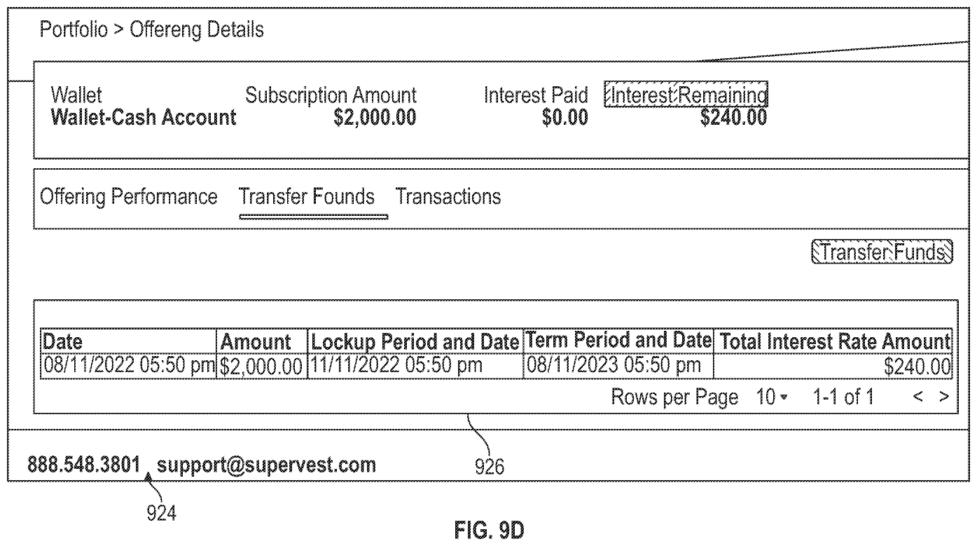

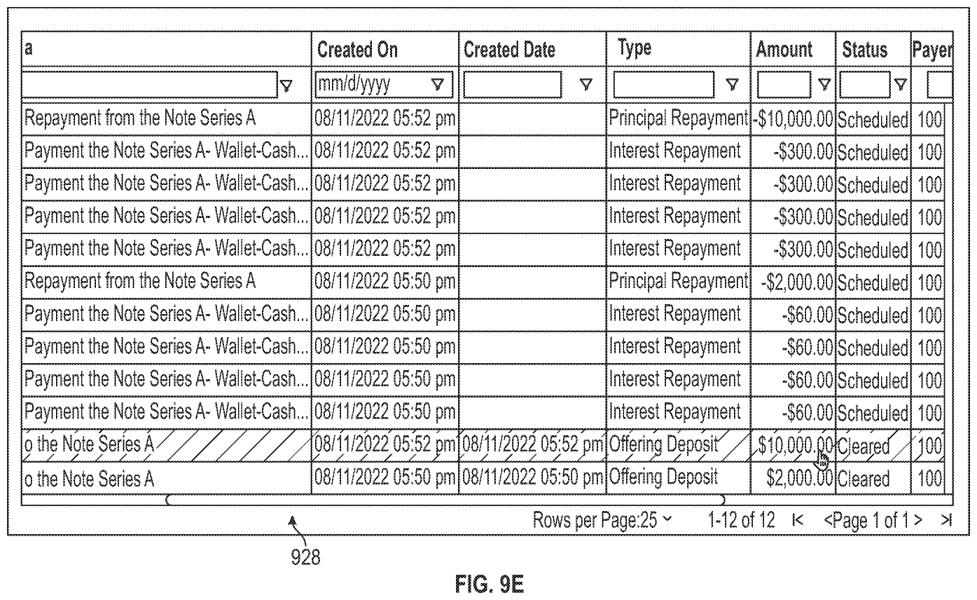

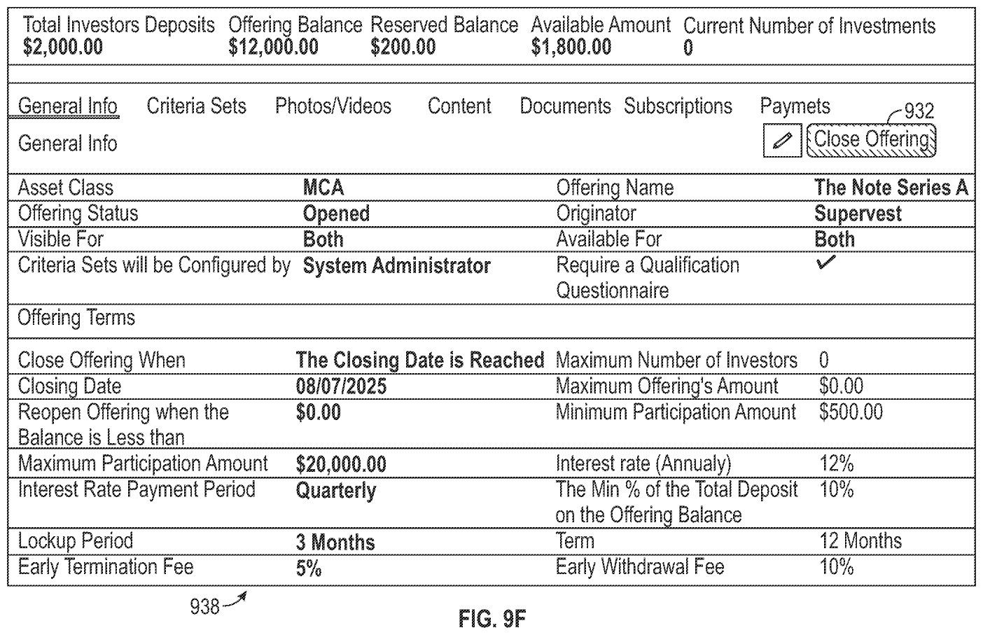

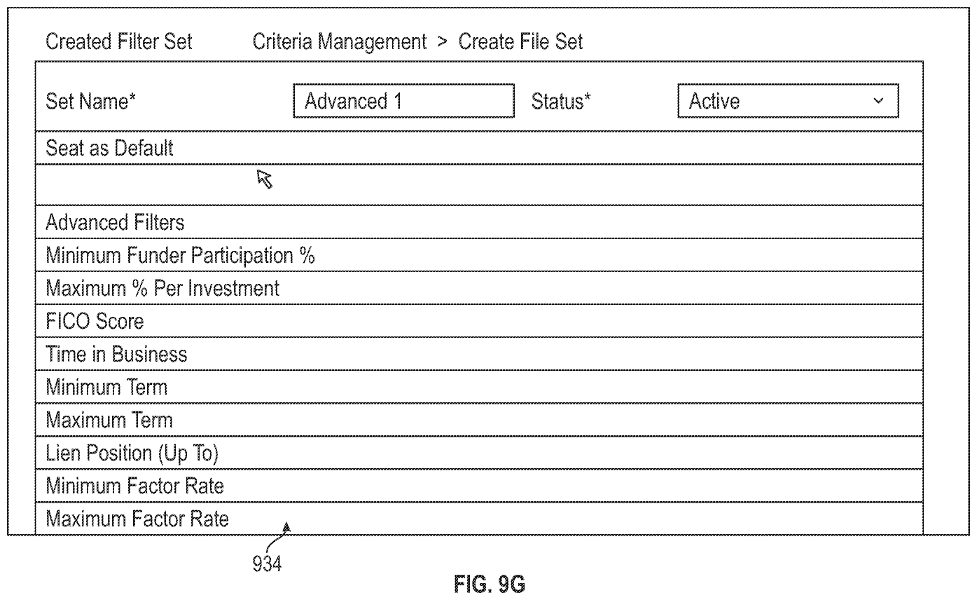

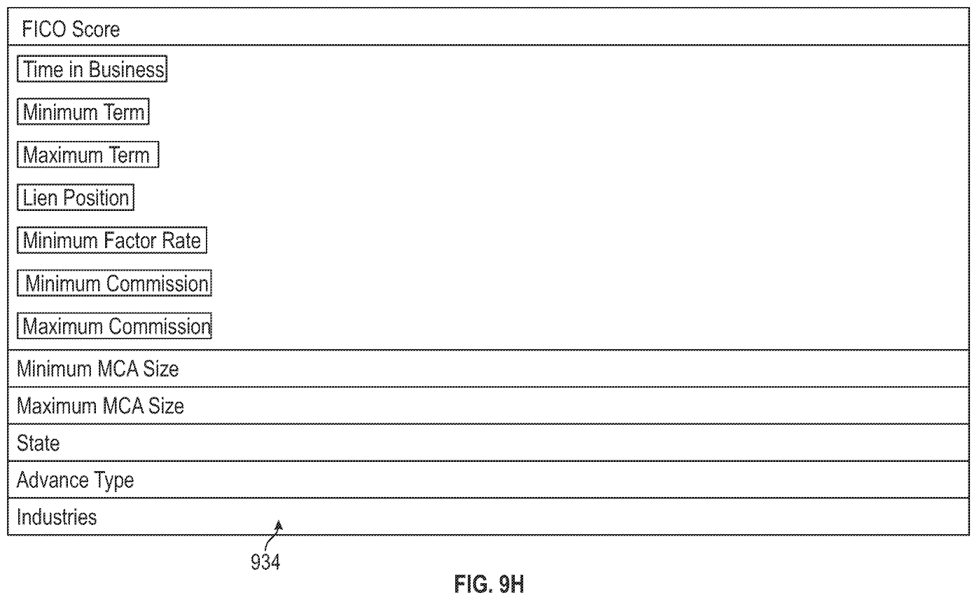

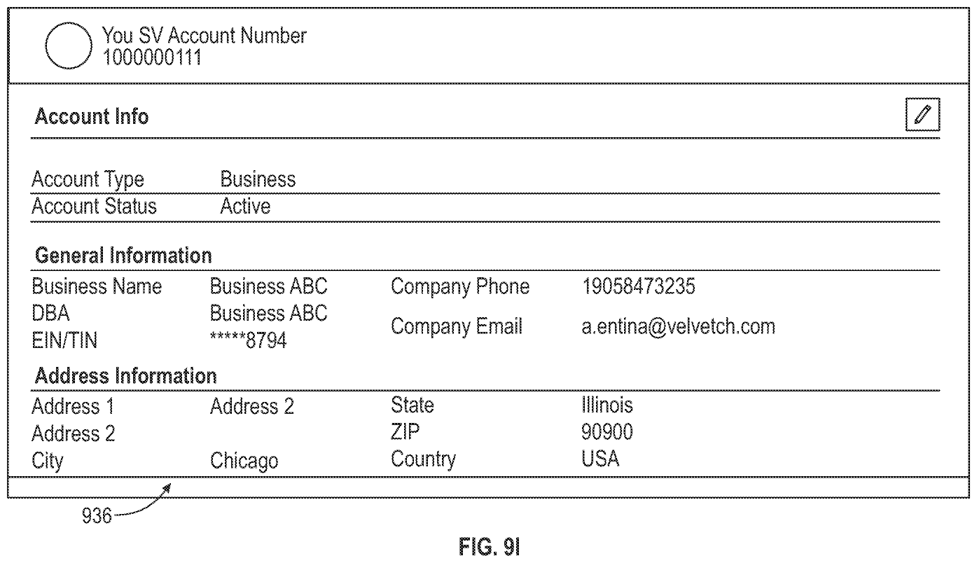

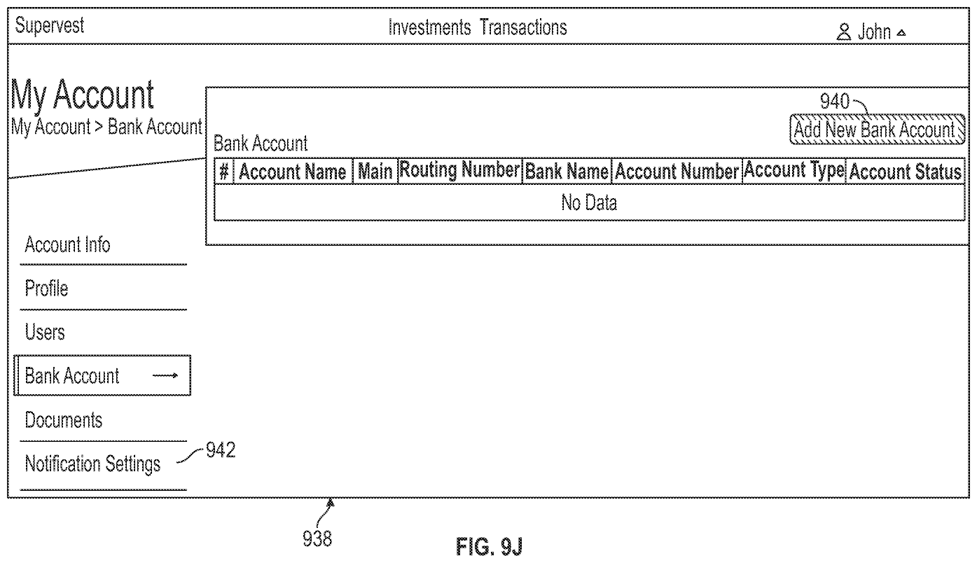

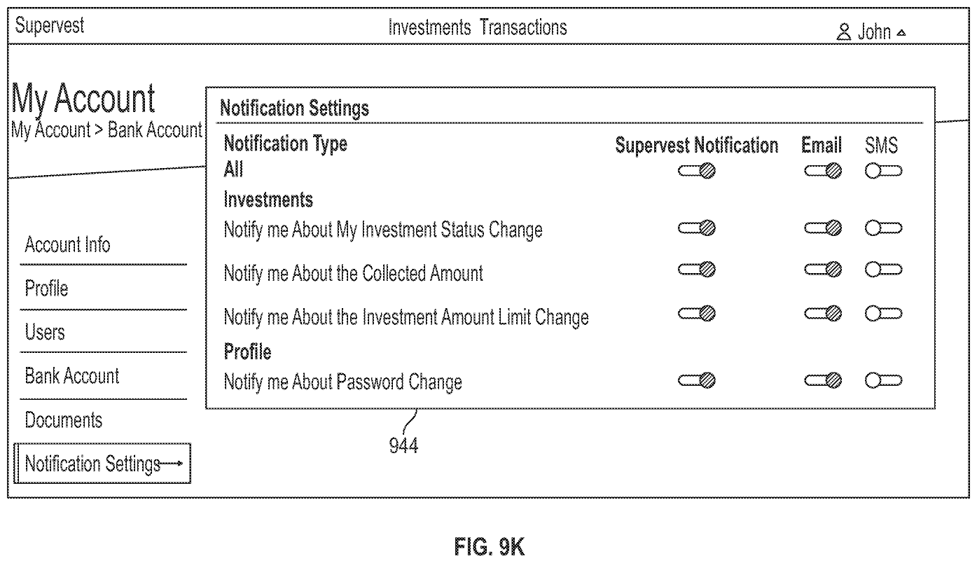

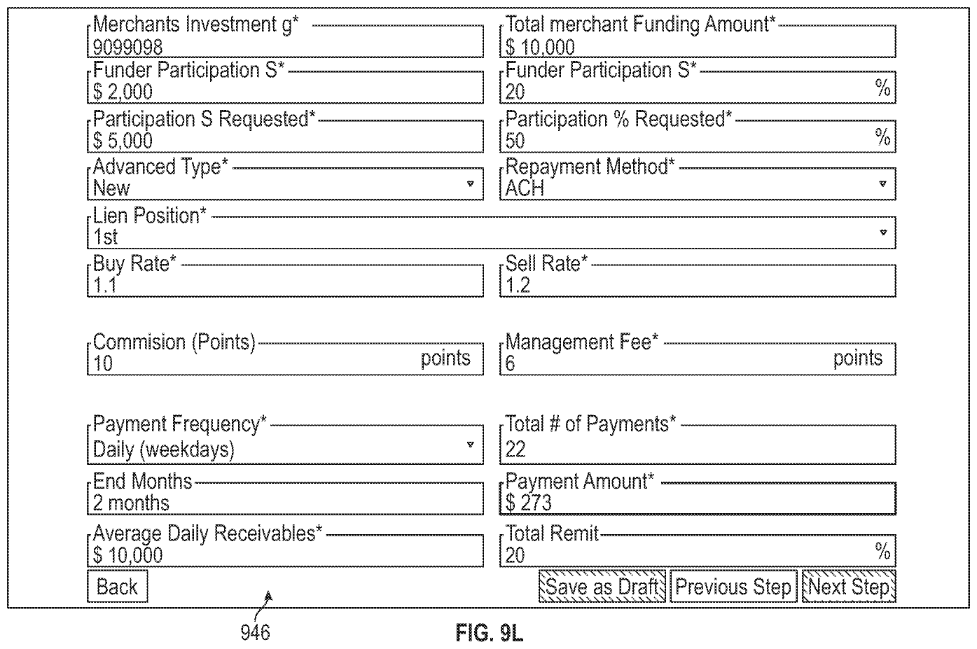

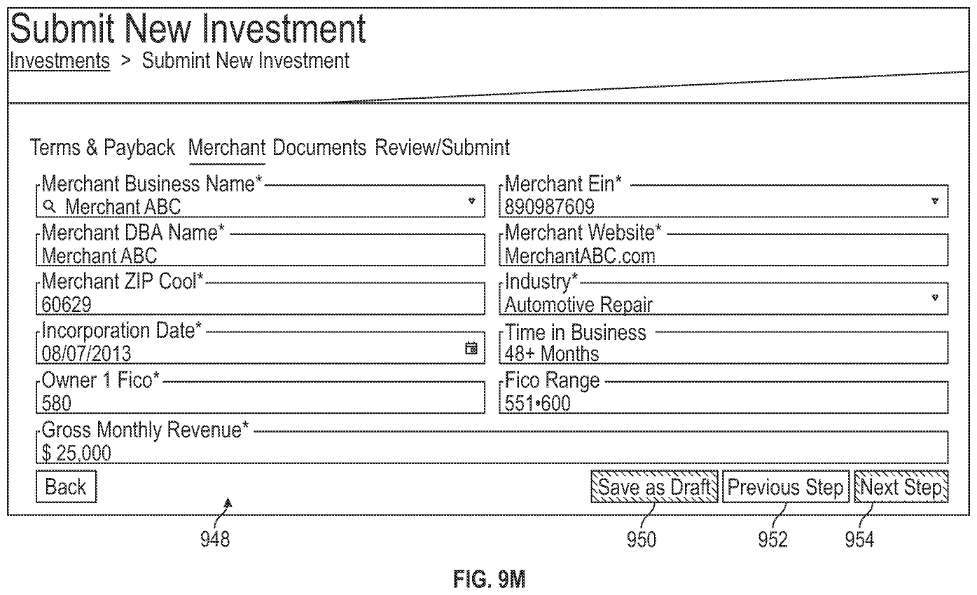

Referring now to FIG. 9A, a user interface screen display 910 is illustrated. The screen display 910 corresponds to data that may be displayed by the investor device or the system administration controller. The screen display 910 includes an investment summary area 912 that may include data including, but not limited to, principal investments, the total commission paid, the total repayment to date and the gross estimated receivable. A wallets and balance portion 914 may include the total amount or balance in the wallet account of the investor.

In offerings and subscriptions portions 916 may list offerings and subscriptions that are active or pending. In this example, data including the name of the offering, the asset class, the wallet, the subscription status, and the offering balance are displayed. Of course, other types of data may be displayed.

A transfer funds button 918 is an electronic button that may be used for controlling the transfer of funds from one account to another account.

Other types of data including the estimated account value and the individual rate of return (IRR) is illustrated.

Referring now to FIG. 9B, when the transfer funds button 918 of FIG. 9A is selected, a transfer box 920 may be displayed. The transfer funds box includes a minimum participation amount, a maximum transfer amount, which is the current amount available at that particular moment, and the amount you want to transfer, which may be entered in the sub box 920A. An indicator as to the current cash balance may also be displayed. A close selector 920B and a confirm selector 920C are also illustrated. FIG. 9B may be used when funds are entered by an investor to be committed to an investment, a promissory note may be displayed and authenticated in FIG. 9C at an authentication screen display 922. A signature area 922A may be displayed so that the funds entered by the investor are committed to an investment.

Referring now to FIG. 9D, a wallet cash account screen display 924 is illustrated that display a transfer of funds illustrated by the box 926. The data corresponding to the transfer of funds corresponds to the date and time, the amount, the lock up period end date, the term period end date, and the total interest rate amount.

In FIG. 9E, an investment screen display 928 is shown in further detail with various data including offering deposits as well as the future interest and principal repayments illustrated by negative signs. The offering deposit is shown within a positive sign while future payments or scheduled payments are shown with negative signs indicating when they are paid.

In FIG. 9F, an offering screen display 930 displays the details of the offering as configured by a system administrator is set forth. The system administrator is allowed to close the offering by selecting a “closed offering button” 932 illustrated in the figure. The system administrator may configure criteria data. In this example, the user interface shows the originator, the display of various types of data, the various offering terms, including when the offer is to be closed, or the closing data as well as when the offering balance drops below a certain level allowing the reopening of the offering. A maximum participation amount, an interest repayment period, a lock up period, an early termination fee, a management fee, the number of investors allowed, the maximum offering amount, the participation amount, the interest rate, the minimum percentage of the total deposits on the offering balance, the term and the early withdrawal may all be provided as part of the offering data.

Referring now to FIGS. 9G and 9H, a filter set screen display 934 may be generated for each offering. For example, various advanced filters, such as the minimum funder participation percentage, the maximum percentage per investment, the FICO score (credit score), the time in business, the minimum term, the maximum term, the lien position, the minimum factor rate, the maximum factor rate, the minimum investment (MCA) size, the maximum investment (MCA) size, the state, an advance type and industries may all be used as investment data used by an investor filter set to determine whether the investment is suitable for the particular investor.

In FIG. 9I, a partner or originator account information screen display 936 is displayed as user interface. The partner or originator may edit the information. As well, a system administrator may edit the various types of information including the name, address, business identifiers of the partner. Data such as address, Employer identification number, a name and DBA, phone number, the account type and the account status.

In FIG. 9J, bank account information screen 938 may displayed into which an investment from the investors may be transmitted. Various account data including the account name, the routing number, the bank name, the account number, the account type and account status may all be changed. Multiple bank accounts may be provided an originator or partner. An add new account button 940 may be used to add a new account and add at least some of the account data.

A partner or originator may also change notification settings by selecting tab 942 as illustrated in FIG. 9K. In FIG. 9K, the different types data for notifications including an application notification, an email notification and a text notification may all be provided for various types of events. The events may include but are not limited to when an investment status changes, when a collected amount changes, when the investment amount limit changes or when a password changes.

In FIG. 9L, an originator or a partner may submit a new investment through new investment user interface 946 by entering various fields for consideration by the system administrator. Some of the fields may be preestablished by the relationship between the originator or partner and the system administration. FIG. 9L has various offering data but is not limited to the data set forth herein. The offering data may include the merchant ID, the merchant funding amount, the funder participation dollars, the funder participation percentage, the participation dollar amount requested, the participation percent requested, an advance type, a payment method, a lien position, a buy rate, a sell rate, commission points, management fees, the payment frequency, the number of payments, the term in months, the payment amount, the average daily receivables of the originator or partner and the total remitted percent.

In FIG. 9M, the partner or originator may submit various merchant data in an originator screen display 948 including the ZIP code, the type of industry, the website, the EIN, the incorporation date, the time and business, the FICO score of the owner, the FICO range and the gross monthly revenue. A Save as draft button 950, a previous step button 952, and a next step button 954 save, and navigate according to the button function.

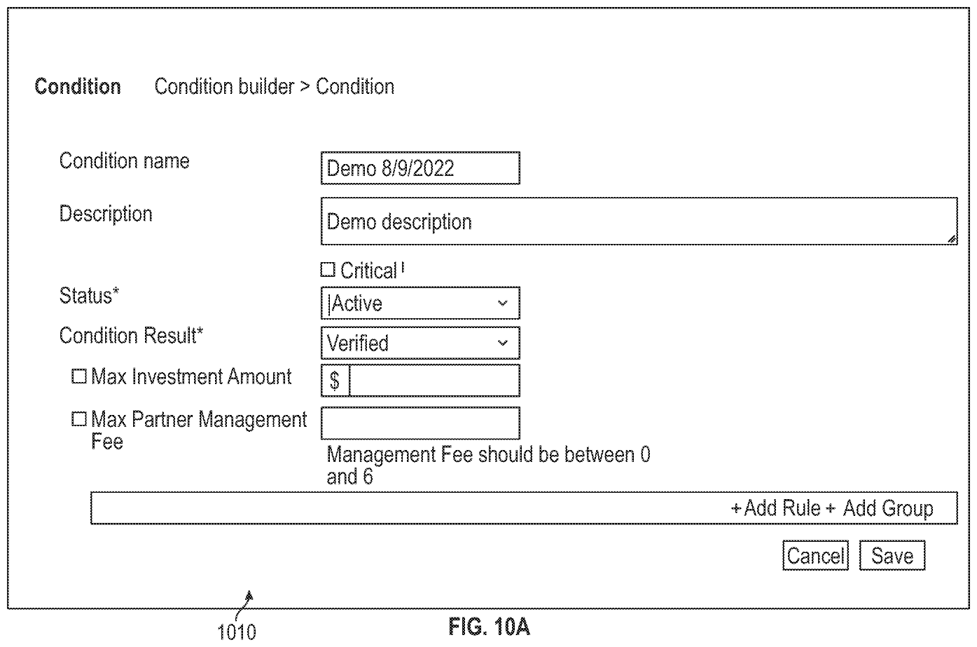

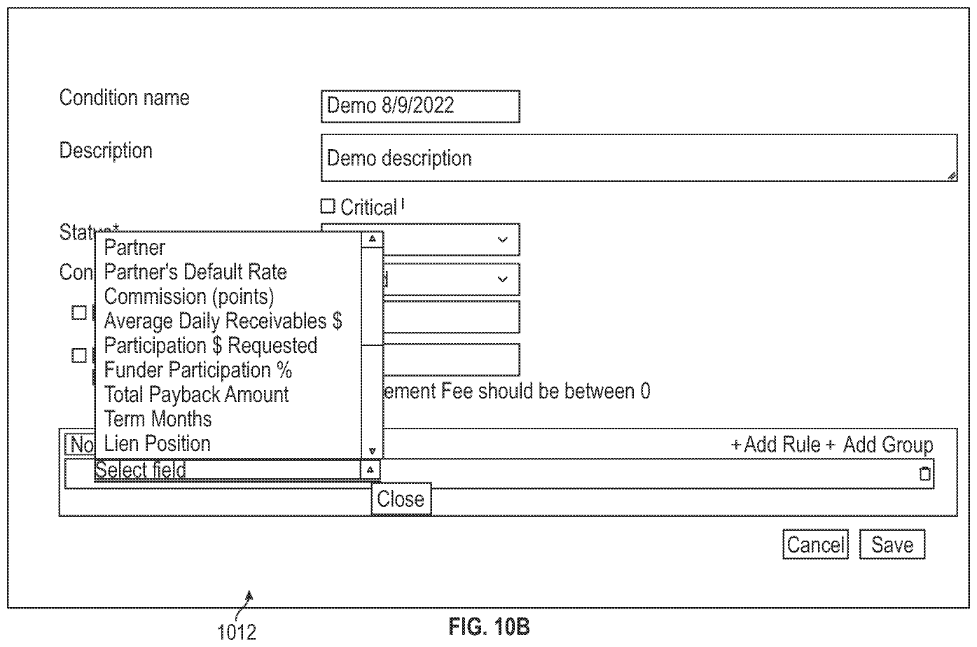

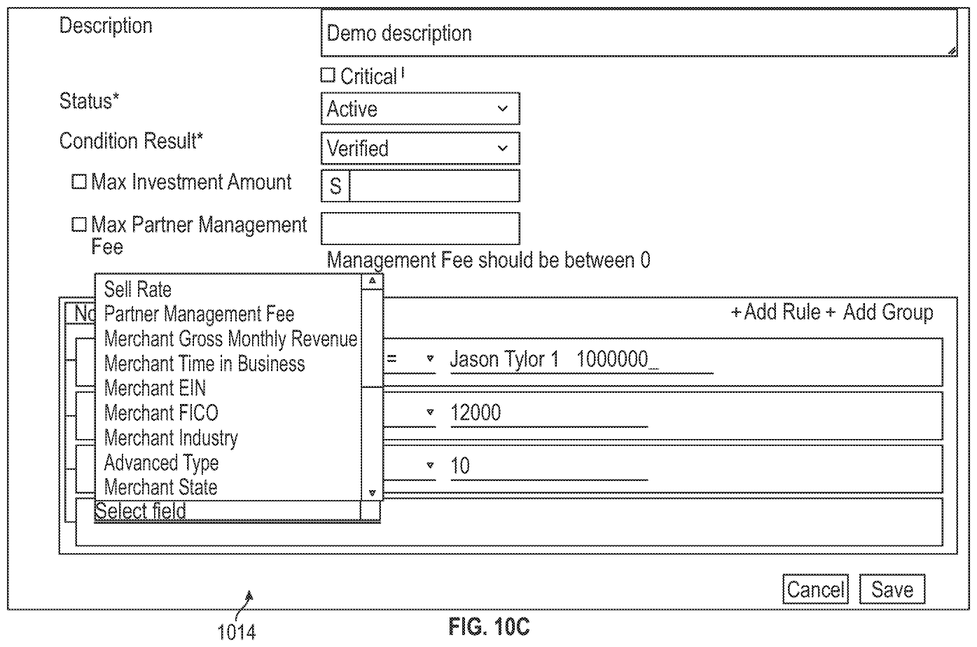

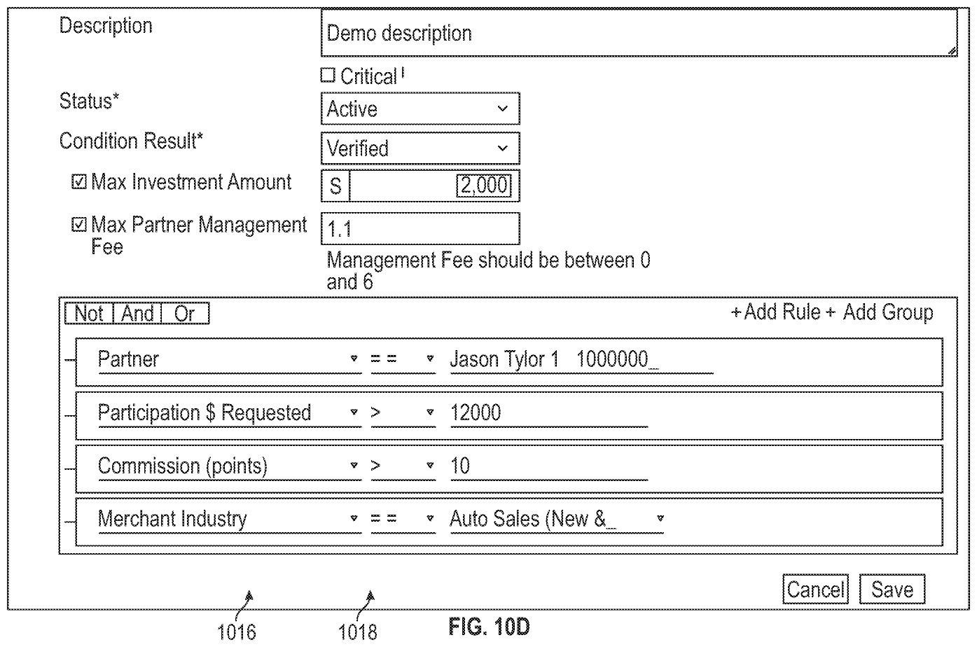

Referring now to FIGS. 10A-10E, the system administrator may configure various verification conditions in order to verify different submissions from originators or partners. The conditions may be referred to as verification condition data. That is, the verification process may be automated by entering various condition data in the condition builder illustrated in FIGS. 10A-10E. In FIG. 10A, a condition name and a description screen display 1010 may be provided for the condition set. The status may be set as active or inactive by the system administrator. The condition result may be verified or unverified. The condition results, such as a maximum investment amount and a maximum partner management fee, may be provided as the result of when the various rules are met.

In FIG. 10B, a screen display 1012 showing various rules may be added and conditions for the originator rules may therefore be added. The rule data sets boundaries for consideration as part of the investment data. A rule data is a combination of condition data and boundary data. For example, the partner, the partner's default rate, the commission in points, the average daily receivables, a participation dollar amount requested, the funder participation percent, total payback amount, the term and months and a lien position may be set forth as condition data. In FIG. 10C, further condition data in a further condition screen display 1014 may also be applied such as buy rate, a sell rate, a partner management fee, a merchant gross monthly revenue, a merchant time in business, a merchant EIN, a merchant FICO score, a merchant industry, and an advanced type. A merchant state is also a condition. The various conditions set forth above along the offering to be filtered and verified. If the partner offering does not meet the filter conditions, the condition result may be “declined”.

As illustrated in FIG. 10D, the condition builder screen display 1016 has a rule builder portion 1018 that is provided with various rules that are combined to determine whether the offering should be verified. The administrator or originator may input the data. In the present example, the verification rules may include verification boundary data, a condition and verification qualifiers such as greater than, less than, equal to, and combinations thereof. The rules may be combined with qualifiers “not”, “and”, “or”. In this example, four different rules are to be applied to a new offering. In this example, when rule is the partner (condition data) is Jason Taylor (boundary data), AND (qualifier) the rule is participation amount requested (condition data) is greater than $12,000 (boundary data), and (qualifier) the commission points (condition data) are greater than 10 (boundary data), AND the industry (condition) is auto sales (boundary sales), the investment amount is set to be $2,000 (result) and the partner management maximum fee is set to be 1.1 (result). Thus, when a new offering is created and the conditions in FIGS. 10A-10D are met, the offering is verified and the results, such as the maximum investment amount and partner management fee, are applied. A plurality of rules (boundaries, qualifiers and conditions) form a criteria set.

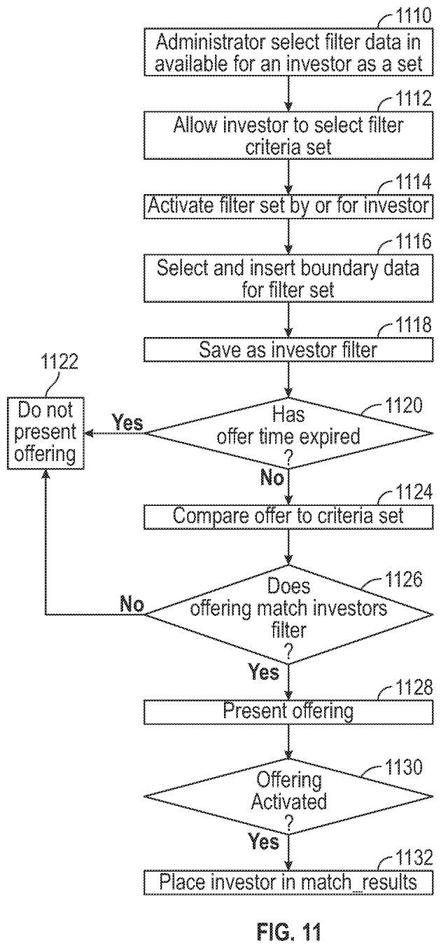

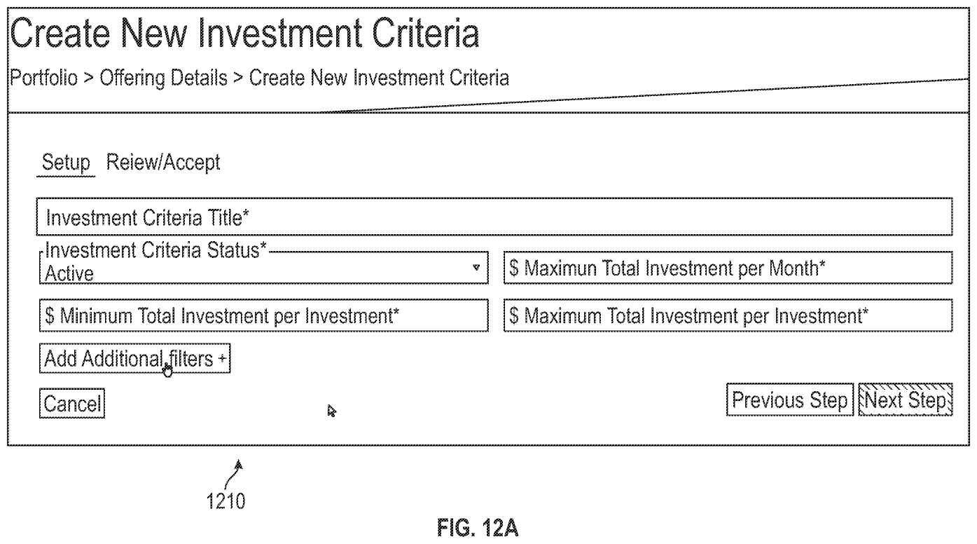

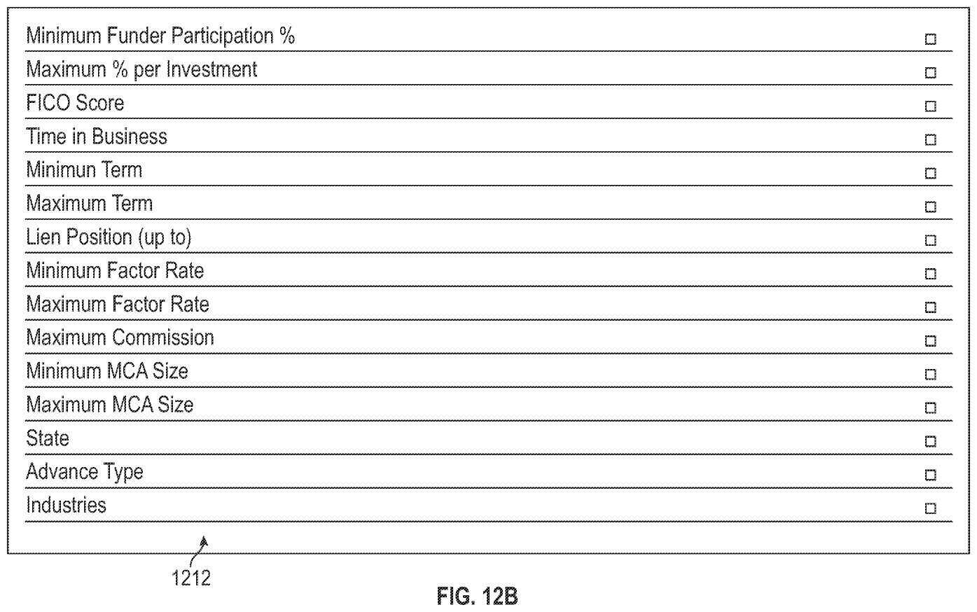

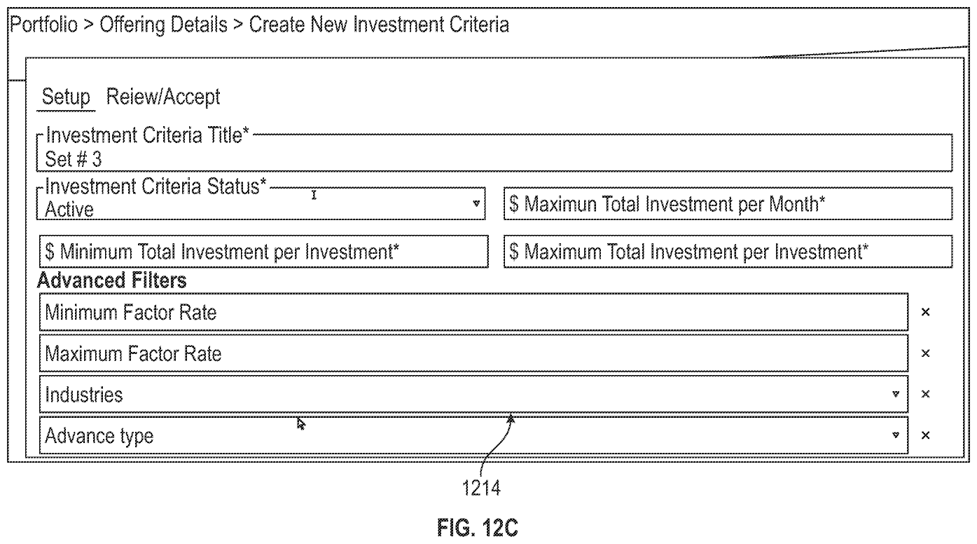

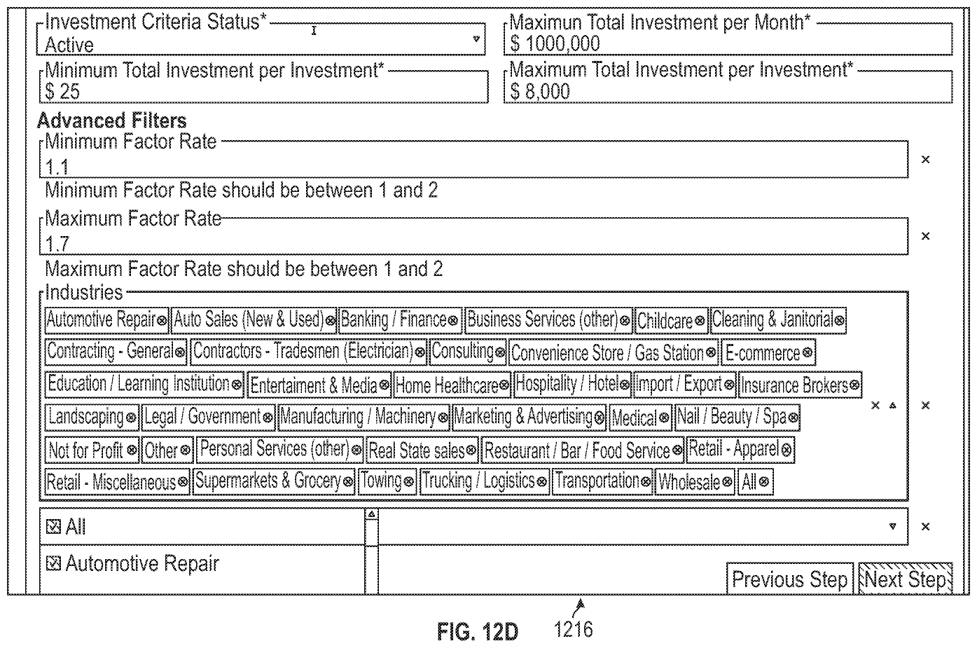

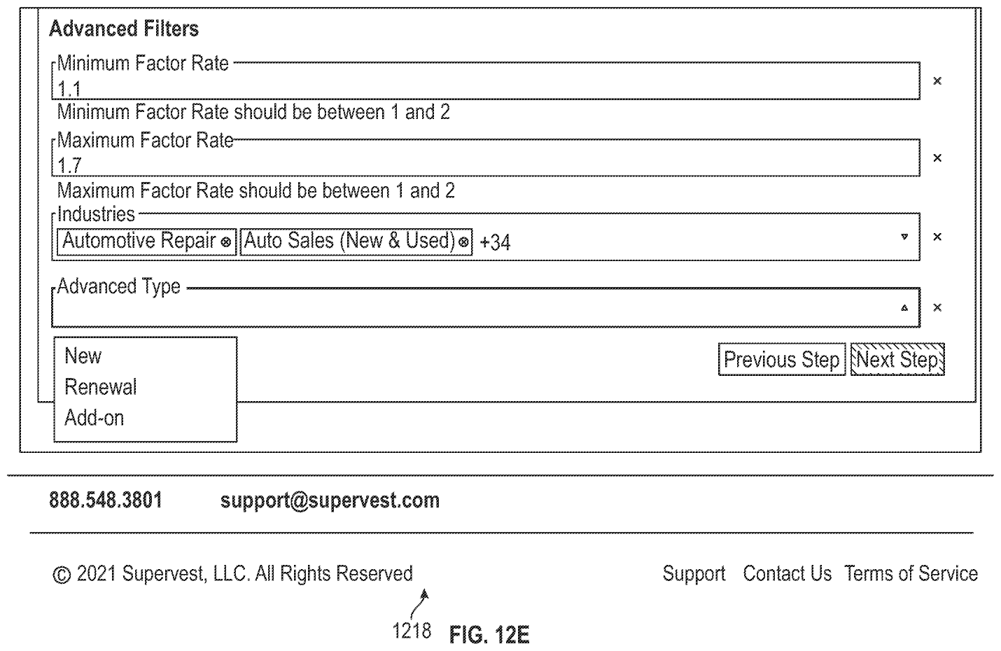

Referring now to FIGS. 11, and 12A-12D in a similar fashion to the above, the administrator selects filter criteria such as condition data that are to be made available for an investor as a set of available filter data in step 1110. That is, an investor may choose a pre-formed criteria set of conditions and rules made by the administrator. There may be a default set of condition data as the investment criteria status, such as active, the maximum total investment per month, the minimum total investment per month and a maximum total investment per investment. The boundary data may then be added by the investor. This is illustrated as the boundary data screen display 1210 in FIG. 12A. The filter set selected by the administrator may be activated in step 1114 by the investor by adding boundary data and form additional filters that are illustrated in the filter screen display 1212 of FIG. 12B.

The investor may select and insert the boundary data or amount data for the rules of the filter set for the different rules in step 1116 and ultimately save the filter set for the selected filter criteria as an investor filter in step 1118. Each investor may have different criteria set for selecting an investment. In FIG. 12B, an example of a plurality of rules in the filter set screen display 1212 with the filter set that may be made available to an investor is set forth. In this example, the offering condition data includes (but is not limited to) the minimum funder participation percentage, a maximum percentage per investment, a credit score, a time in business, a minimum term, a maximum term, a lien position (up to), a minimum factor rate, a maximum factor, a maximum commission, a minimum investment (MCA) size, a maximum investment (MCA) size, a state, an advance type and the industry or industries. After the boundary data is set for the rules of the filter set, the investor saves the offering filter as a custom filter associated with their account. Once the offering filter is activated, various offerings are presented to the investor based upon the filter.

Each of the offerings has a time and therefore if the time has expired in step 1120, the offering is not presented to the investor in step 1122. When the time has not expired in step 1120, various offers and the data associated with the offers are compared to the investor's filter criteria set in step 1124. Examples of rule data and boundary data placed into the investor filter criteria set is set forth in FIG. 12C as screen display 1214, in FIG. 12D as screen display 1216 and FIG. 12E as screen display 1218. In FIGS. 12C, 12D and 12E, the rule data combines condition data and boundary data such as the maximum total investment per month (condition data) is $100,000 (boundary data); the minimum total investment per investment (condition data) is $25.00 (boundary data), the maximum total investment per investment (condition data) is $8,000 (rule data). Advanced filters are also provided in FIG. 12D. The advanced filters are the conditions made available to investors by the system administrator in addition to the default conditions. The advance filters in this example show rules of: a minimum factor rate (condition) of 1.1 (boundary), a maximum factor rate (condition) of 1.7 (boundary), the various industries have been selected as “all” and in FIG. 12D, a selection made for the advanced type, such as new, renewal or add-on. New means the offering is a brand-new offering. A renewal is a renewal of the offering while add-on is an extension of a previous offering. When the offer matches the investor filter criteria set in step 1126, the system in step 1128 presents the offering to the investor. Once the investor accepts the invitation in step 1130, the investments are loaded into a participant table and thus when an investor participates, the investment may appear in the portfolio of the investor as illustrated in FIG. 9A in step 1132.

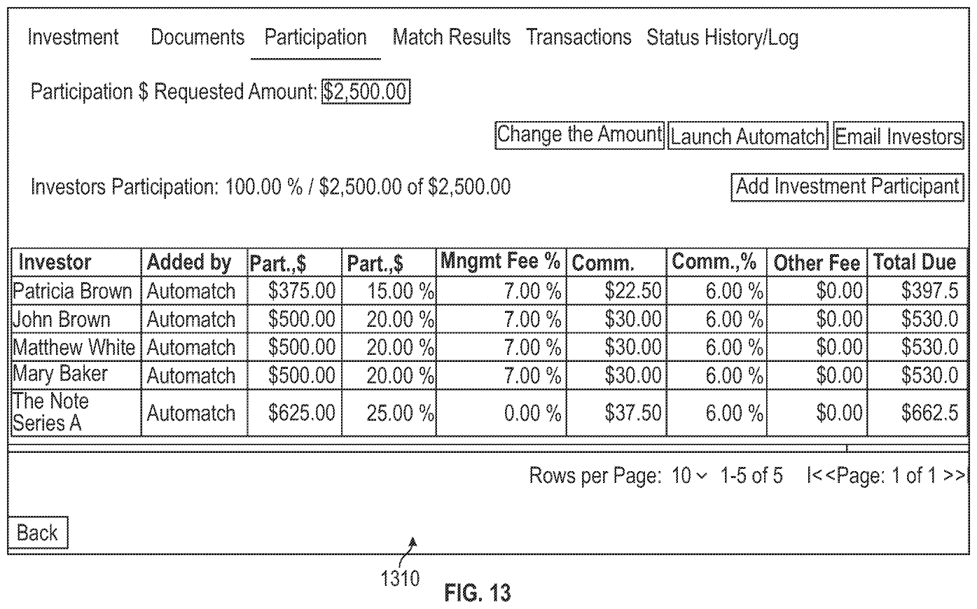

As illustrated in FIG. 13, the investment may also be displayed by the system administration controller together with other investors. In FIG. 13, a screen display 1310 showing data corresponding to the participation of various investors may be different based upon the percentage or the participation dollar amount. Other data, such as the management fee, the commission, the commission dollar amount, or other fees may be illustrated for the investment.

The screen displays set forth in the present disclosure provide examples of data that may be provided and considered in an investing system. More data or a lesser amount of data may be used for the investment and the for the filter criteria set. Further, although the system and screen displays are suitable for MCAs other types of investments may benefit with the teachings of the present disclosure.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of allocating investors to an investment comprising:
receiving an investment request signal for the investment, said investment request signal corresponding to a requested investment amount;
determining an investment quality rating for the investment;
determining an investor group size for an investor group of investor devices based on the investment quality rating, each investor device comprising a criteria set of a plurality of criteria sets;
determining an investor participation amount for each investor device based on the plurality of criteria sets;
generating an investor queue based on the plurality of criteria sets;
communicating an investment offer to a plurality of investor devices in the queue;
receiving from the plurality of investor devices a participation confirmation signal;
storing participating investors in a participant table in a memory; and
communicating notification signals to the plurality of investor devices in the participant table corresponding to acceptance into the investment.

2. The method of claim 1 wherein after determining the investor group size determining an approximate participation amount.

3. The method of claim 1 wherein receiving the investment request signal comprises receiving the investment amount and investment data.

4. The method of claim 3 wherein the investment data comprises at least four of a merchant investment identifier, a total merchant funding amount, a funder participation dollar amount, a funder participation percentage amount, a participation dollar requested amount, a participation percent requested amount, and an advance type.

5. The method of claim 4 wherein the advance type comprises a new investment, a renewal investment or an add-on investment.

6. The method of claim 1 wherein determining an investment quality rating comprises determining at least one of a time in business, a credit score, a lien position, a participation amount and an investment default rate.

7. The method of claim 1 wherein determining an investment quality rating comprises determining at least two of a time in business, a credit score, a lien position, a participation amount and an investment default rate.

8. The method of claim 1 wherein determining an investment quality rating comprises determining at least two of a time in business, a credit score, a lien position, a participation amount and an investment default rate.

9. The method of claim 1 further comprising wherein when the plurality of investor devices does not reach a goal, inviting investor devices with a second criteria set.

10. The method of claim 1 wherein determining the investor participation amount comprises determining the investor participation amount based on the requested investment amount, a buy rate and a sell rate.

11. The method of claim 1 further comprising displaying participating investors on a screen display.

12. The method of claim 1 wherein associating the criteria set comprises associating the criteria set from a plurality of criteria sets with each of the investor devices.

13. The method of claim 1 further comprising sorting the investor devices in the queue by a rating of investor characteristics.

14. The method of claim 13 wherein the rating of investor characteristics comprises an internal rate of return.

15. The method of claim 13 wherein the rating of investor characteristics comprises cash flows and dates that correspond to the cash flows.

16. The method of claim 1 wherein the plurality of criteria sets comprise a plurality of rules.

17. The method of claim 16 wherein the plurality of rules comprises boundaries, qualifiers and conditions.

18. The method of claim 16 wherein the plurality of rules based on at least three of minimum funder participation percentage, a maximum percentage per investment, a credit score, a time in business, a minimum term, a maximum term, a lien position, a minimum factor rate, a maximum factor, a maximum commission, a minimum investment size, a maximum investment size, a state, an advance type and an industry or industries.

19. A system for allocating investors to an investment comprising:
a system administration controller;
a plurality of investor devices;
an originator device communicating an investment request signal for the investment to the system administration controller, said investment request signal corresponding to a requested investment amount;
said system administration controller determining an investment quality rating for the investment, determining an investor group size for an investor group of investor devices based on the investment quality rating, each investor device comprising a criteria set of a plurality of criteria sets, determining an investor participation amount for each investor device based on the plurality of criteria sets, generating an investor queue based on the criteria sets, and communicating an investment offer to the plurality of investor devices in the queue;
the plurality of investor device communicating a participation confirmation signal to the system administration controller; and
the system administration controller storing participating investors in a participant table in a memory and communicating notification signals to the plurality of investor devices in the participant table corresponding to acceptance into the investment.
